(19) United States
(12) Patent Application Publication
(10) Pub. No.: US 2010/0131566 A1
(43) Pub. Date: May 27, 2010

(54) INFORMATION PROCESSING METHOD, INFORMATION PROCESSING APPARATUS, AND STORAGE MEDIUM

(75) Inventor: Junko Sato, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/626,040

(22) Filed: Nov. 25, 2009

(30) Foreign Application Priority Data
Nov. 26, 2008 (JP) 2008-301212

(51) Int. Cl. G06F 17/30

(52) U.S. Cl. 707/802; 707/E17.005

(57) ABSTRACT

An information processing apparatus is capable of editing an original file having a hierarchical structure, which includes a chapter, page by page. The information processing apparatus designates a second original file to be imported into a first original file and imports each page included in the designated second original file into a top of each chapter of the first original file.

### BACKGROUND OF THE INVENTION

1. Field of the Invention

The present invention relates to an information processing method and an information processing apparatus configured to provide a print setting function for executing a setting for printing document data generated by a document processing program, and a storage medium storing a program for the print setting function.

2. Description of the Related Art

In editing various types of data including a character, a table, and an image, the structures of a definition of the data differ from one another. In addition, in this case, it is necessary to execute different operations for editing the different types of data. Therefore, various application programs have been marketed, which are compliant with the various types of data.

Accordingly, it is necessary for a user of various data to use different applications for different types of data. More specifically, the user is required to use a text processing program, a spreadsheet program, and an image editing program for editing text data, a spreadsheet, and an image, respectively.

As described above, a user of various data generally uses different dedicated application programs for different types of data. However, in general, a user often generates or processes a document including a plurality of types of data, such as data including text data and a spreadsheet or data including text data and an image, rather than data including a specific type content only, such as data including text data only, a spreadsheet only, or an image only.

In a conventional method, in order to generate a document including a plurality of types of data, it is necessary for a user to generate a desired document by printing each data by utilizing a printing function of each application and by sorting resulting print products in a desired order.

On the other hand, an office suite, which is a program including an integrated application, which integrally includes functions of various types of applications, provides a function for generating and processing one document by combining data generated by each application.

By using the integrated application described above, a user can generate one document including various data generated by using various different applications by using a specific application included in the integrated application.

However, in generating a desired document including a combination of print products generated by various applications, in order to assign a page number on each page, it is necessary for a user to determine the page number to be assigned after sorting out necessary data that has been completely printed and output.

In addition, if a user uses an application program including a function for assigning a page number, if adjacent pages including non-continued pages exist, it is necessary for the user to designate a page number for the non-continued pages. If pages of a document are rearranged, it is necessary for the user to assign new page numbers. In addition, it may also become necessary for the user in this case to reedit or reprint the data by using the application, by combining a plurality of original pages into one page of a print product (a logical page or a print page) or changing the printing mode from one-sided printing to two-sided printing.

As described above, because the types of applications that can manage specific type data differ according to the data type, it is necessary for the user to manually provide an interface between applications. Accordingly, the user is required to execute a large number of operations. Therefore, the productivity may degrade. In addition, in the above-described conventional method, it is necessary for the user to manually execute a large number of operations. Therefore, it is likely that the user makes a mistake during the operations.

On the other hand, in generating a document by utilizing the integrated application, a user can arrange various types of data by utilizing a print preview function without actually printing the data of the document, in which the state after printing the document data is displayed on a screen.

By using the above-described function, the number of operations required to the user is smaller than that in the case of generating a document by combining print products. However, the application for editing and generating various data is limited to an application included in an integrated application. Therefore, the user cannot always utilize a desired application.

A document generated by the integrated application is in the form of a single document file. Therefore, the document is managed (edited or output) in the unit of a file. Accordingly, if a user desires to set a format to a part of a document file, the user is restricted to execute the setting due to the restriction by the function of the application.

More specifically, it is necessary, in this case, for the user to execute an operation for changing a format setting for each of portions of the document having a different format and execute a printing operation for each such portion. Accordingly, in both of the above-described conventional methods, the user is required to execute a large number of operations, which may degrade the productivity.

Under these circumstances, in which an integrated application has a large number of functions, users of information processing apparatuses recently desire an environment in which all desktop publishing (DTP) operations can be executed on a computer.

More specifically, a user of an information processing apparatus desires an environment in which a document file can be printed by inserting an index sheet (including data of a page different from original pages) having a tab into the document file.

A conventional method discusses the following method. In the conventional method, document information including a combination of data generated by application programs desired by the user is generated. In addition, an index sheet is inserted between printing sheets on which print data of the document information is printed. In this conventional method, a user designates a character string to be printed on a tab portion of the index sheet and the index sheet having the tab portion is printed.

When an integrated application discussed in Japanese Patent Application Laid-Open No. 2004-206170 is used, an index sheet is inserted between printing sheets and a character string is printed in a tab portion of the index sheet. If a format of a character string to be printed in the tab portion is set, the conventional method prints the index sheet according to the set format.

In addition, the method discussed in Japanese Patent Application Laid-Open No. 2004-206170 includes a function for generating a document based on a combination of data generated by various applications. By using the integrated application described above, a user can generate a document by using a specific application included in the integrated application based on the data generated by using various types of applications.

However, if a conventional integrated application described above is used, in importing data including data of a plurality of pages and generated by various types of applications, the plurality of pages is always inserted in a lump in a specific location.

Accordingly, if it is desired to import data including data of a plurality of pages, which is generated as data to be printed on an index sheet, and to print the imported data on an inserted sheet such as an index sheet, it is necessary for the user to manually move the data to the top of each chapter of the document data to print the document data in a desired printing order.

### SUMMARY OF THE INVENTION

The present invention is directed to an information processing method capable of importing data for an inserted sheet such as an index sheet into an original file in an appropriate format.

According to an aspect of the present invention, an information processing method for editing an original file having a hierarchical structure including a chapter page by page includes designating a second original file to be imported into a first original file, and executing first importing processing for importing each page included in the designated second original file by arranging each page of the second original file into a top of each chapter of the first original file.

According to an exemplary embodiment of the present invention, a user can import data to be printed on an inserted sheet such as an index sheet into an original file in an appropriate format.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 is a block diagram illustrating an exemplary configuration of a stand-alone type document processing system according to an exemplary embodiment of the present invention.

FIG. 2 is a block diagram illustrating an exemplary configuration of a host computer of the document processing system according to an exemplary embodiment of the present invention.

FIGS. 3A and 3B illustrate an example of a structure of a book file according to an exemplary embodiment of the present invention. More specifically, FIG. 3A illustrates an example of a format of a book file while FIG. 3B illustrates an example of a structure of original data according to an exemplary embodiment of the present invention.

FIG. 4 illustrates an example of a list of book attributes according to an exemplary embodiment of the present invention.

FIG. 5 illustrates an example of a list of chapter attributes according to an exemplary embodiment of the present invention.

FIG. 6 illustrates an example of a list of page attributes according to an exemplary embodiment of the present invention.

FIG. 7 is a flow chart illustrating an example of processing for opening a book file according to an exemplary embodiment of the present invention.

FIG. 8 is a flow chart illustrating an example of processing for importing an electronic original file into a book file according to an exemplary embodiment of the present invention.

FIG. 9 is a flow chart illustrating an example of processing for converting the application data into an electronic original file according to an exemplary embodiment of the present invention.

FIG. 10 illustrates an example of a user interface screen displayed when an existing book file is opened according to an exemplary embodiment of the present invention.

FIG. 11 illustrates an example of a user interface screen displayed when a new book file is opened according to an exemplary embodiment of the present invention.

FIG. 12 is a block diagram illustrating an exemplary configuration of a client-server type document processing system according to an exemplary embodiment of the present invention.

FIG. 13 is a block diagram illustrating an exemplary configuration of a host computer and a printer included in a document processing system according to an exemplary embodiment of the present invention.

FIG. 14 is a flow chart illustrating an example of processing for printing a character string in a tab portion of an inserted sheet, which is executed in the document processing system according to an exemplary embodiment of the present invention.

FIG. 15 illustrates an example of a user interface (UI) screen for executing a setting for inserting an index sheet according to an exemplary embodiment of the present invention.

FIG. 16 illustrates an example of a UI screen for setting a character string to be printed on a tab portion of an index sheet according to an exemplary embodiment of the present invention.

FIG. 17 illustrates an example of a UI screen for setting a character string to be printed on a tab portion of an index sheet according to an exemplary embodiment of the present invention.

FIG. 18 illustrates an example of a UI screen for setting a character string to be printed on a tab portion of an index sheet according to an exemplary embodiment of the present invention.

FIG. 19 illustrates an example of a structure of data of a document file according to an exemplary embodiment of the present invention.

FIG. 20 illustrates an example of a data structure of detailed setting information about a document according to an exemplary embodiment of the present invention.

FIG. 21 illustrates an example of information about an index sheet for each chapter according to an exemplary embodiment of the present invention.

FIG. 22 illustrates an example of detailed setting information about each chapter according to an exemplary embodiment of the present invention.

FIG. 23 illustrates an example of a data structure of page setting information about the each chapter according to an exemplary embodiment of the present invention.

FIG. 24 illustrates an example of a display displayed during processing for editing information about a tab of an index sheet according to an exemplary embodiment of the present invention.

FIG. 25 is a flow chart illustrating an example of processing for editing index sheet information and controlling a preview display according to an exemplary embodiment of the present invention.

FIG. 26 is a flow chart illustrating an example of processing for executing a setting to an index sheet according to an exemplary embodiment of the present invention.

FIG. 27 is a flow chart illustrating an example of processing for printing information about a document including an index sheet according to an exemplary embodiment of the present invention.

FIG. 28 illustrates an example of a preview display of an original page including an index sheet when a print setting for printing data on an index sheet and a tab is executed according to an exemplary embodiment of the present invention.

FIG. 29 illustrates an example of a UI screen for setting a method for importing an electronic original format into a book file according to an exemplary embodiment of the present invention.

FIG. 30 is a flow chart illustrating an example of processing for importing an electronic original format into a book file according to an exemplary embodiment of the present invention.

FIG. 31 is a flow chart illustrating an example of processing for importing an electronic original format into a book file according to an exemplary embodiment of the present invention.

FIG. 32 is a flow chart illustrating an example of processing for importing an electronic original format into a book file according to an exemplary embodiment of the present invention.

FIG. 33 illustrates an example of a UI screen for setting whether to import an electronic original format as a index sheet prating page according to an exemplary embodiment of the present invention.

FIG. 34 illustrates an example of a UI screen for registering the size of an index sheet-printing page according to an exemplary embodiment of the present invention.

FIG. 35 is a flow chart illustrating an example of processing for importing an electronic original format into a book file according to an exemplary embodiment of the present invention.

FIG. 36 illustrates an example of a UI screen displayed when a book file including an index sheet-printing page is opened according to an exemplary embodiment of the present invention.

FIG. 37 illustrates an example of a UI screen displayed when a book file including an index sheet-printing page is opened according to an exemplary embodiment of the present invention.

FIG. 38 illustrates an example of a UI screen for issuing an instruction for rearranging original pages included in a book file according to an exemplary embodiment of the present invention.

FIG. 39 is a flow chart illustrating an example of processing for rearranging original pages included in a book file according to an exemplary embodiment of the present invention.

FIG. 40 is a flow chart illustrating an example of processing for rearranging original pages included in a book file according to an exemplary embodiment of the present invention.

### DESCRIPTION OF THE EMBODIMENTS

Various exemplary embodiments, features, and aspects of the invention will be described in detail below with reference to the drawings.

Now, a first exemplary embodiment of the present invention will be described in detail below. In a document processing system according to the present exemplary embodiment, a data file generated by a general application is converted into an electronic original file by an electronic original writer. A bookbinding application provides a function for editing the electronic original file.

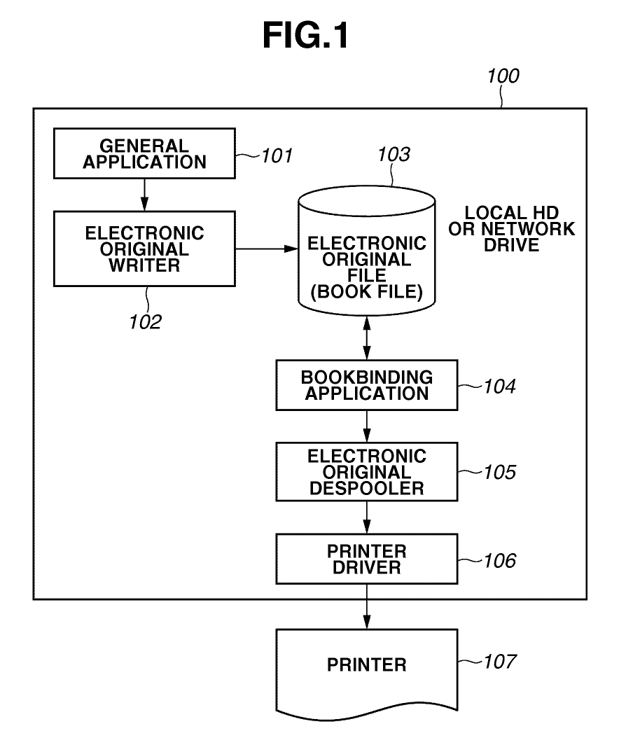

FIG. 1 illustrates an exemplary software configuration of the document processing system according to the present exemplary embodiment. The document processing system is implemented by a host computer 100, which is an exemplary embodiment of an information processing apparatus of the present invention.

A general application 101 is an application program that provides various functions, such as a word processing function, a spreadsheet function, a photo retouch function, a draw or paint function, a presentation function, and a text editing function. The general application 101 has a printing function for an operating system (OS).

In printing application data, such as generated document data or image data, the general application 101 utilizes a predetermined interface (a graphic device interface (GDI)) which is provided by the OS.

More specifically, an arbitrary general application 101 transmits an output command (a “GDI function”) of a predetermined format dependent on the OS to an output module of the OS that provides a predetermined interface to print the generated data. After receiving the output command, the output module converts the output command into a format that an output device, such as a printer, can process. Then, the output module outputs the converted command (a device driver interface (DDI) function).

The format that the output device can process may be different according to a type, manufacturer, and a model of the device. Accordingly, a unique device driver for controlling the device is provided to each device. The OS uses the device driver to convert the command, generates print data, and describes it in a job language (JL) to generate a print job. When Windows® of Microsoft Corporation is used as the OS (operating system), a module called GDI corresponds to the output module described above.

An electronic original writer 102 is an improvement of the above-described device driver. The electronic original writer 102 is a software module provided to realize the present document processing system. However, the electronic original writer 102 does not target a specific output device but instead converts the output command into a command of a format that can be processed by a bookbinding application 104 and a printer driver 106 to generate an electronic original file 103. The bookbinding application 104 and the printer driver 106 will be described in detail below.

The format after the conversion (hereinafter referred to as an “electronic original format”) by the electronic original writer 102 may be any format only if each original page can be expressed in a detailed form. Among substantial standard formats, the portable document format (PDF) format of Adobe Systems, Inc. and the Standardized Generalized Markup Language (SGML) format provided by World Wide Web Consortium (W3C), for example, can be employed as the electronic original format.

When the electronic original writer 102 is utilized by the general applications 101, the electronic original writer 102 is designated as a device driver to be used for output before executing printing. However, an electronic original file just generated by the electronic original writer 102 does not have a complete format as an electronic original file.

Therefore, the bookbinding application 104 designates the electronic original writer 102 as a device driver. Application data is converted into an electronic original file under control of the bookbinding application 104. The bookbinding application 104 completes a new and incomplete electronic original file generated by the electronic original writer 102 as an electronic original file having a format to be described later.

Hereinbelow, a file generated by the electronic original writer 102 is referred to as an “electronic original file” and an electronic original file that has been given a structure by the bookbinding application 104 is referred to as a “book file”. Otherwise, a document file generated by an application, an electronic original file, and a book file, the file is collectively referred to as a “document file” (or “document data”).

As described above, the electronic original writer 102 is designated as the device driver and the general application 101 prints the application data. Thus, the application data is converted into an electronic original format. The application data of the electronic original format is stored on a storage medium such as a hard disk as a converted electronic original file (i.e., a book file) 103. The application data is converted into an electronic original format in the unit of a page defined by the general application 101 (hereinafter referred to as a “logical page” or an “original page”).

As the hard disk, a local drive included in the host computer 100 that implements the document processing system according to the present exemplary embodiment can be used. Alternatively, if communication via a network is available, a drive provided on the network can be used as the hard disk.

The bookbinding application 104 provides the user with a function for reading the electronic original file (book file) 103 and editing the read book file 103. However, the bookbinding application 104 does not include a function for editing the content of each page but provides a function for editing the structure of a chapter and a book, which include a page as their minimum unit. A “chapter” and a “book” will be described in detail below.

In printing the book file 103 that has been edited by the bookbinding application 104, the bookbinding application 104 activates an electronic original despooler 105.

The electronic original despooler 105 reads a designated book file 103 from the hard disk. Further, the electronic original despooler 105 generates an output command compliant with the output module of the OS to print each page in the format described in the read book file 103 and outputs the generated output command to the output module (not illustrated). In outputting the output command to the output module, the printer driver 106 of the printer 107 which is used as an output device is designated as a device driver.

The output module converts the output command received by using the designated printer driver 106 of the printer 107 into a device command that the printer 107 can interpret and execute. Then, the device command is transmitted to the printer 107. The printer 107 prints an image according to the received device command on a print sheet.

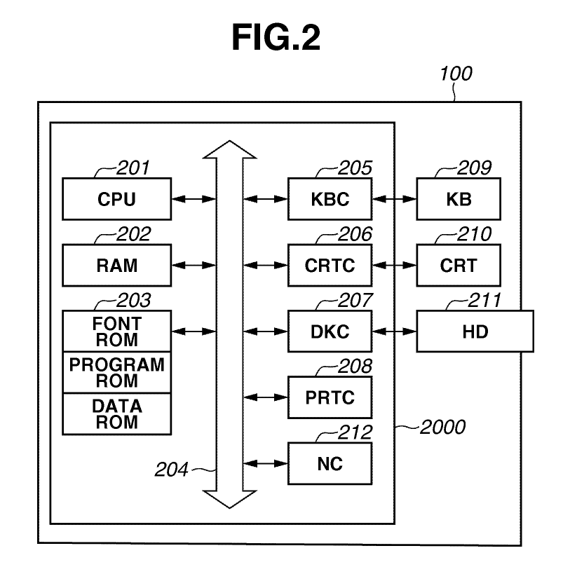

FIG. 2 illustrates an exemplary hardware configuration of the digital computer 100 (FIG. 1) according to the present exemplary embodiment.

Referring to FIG. 2, the host computer 100 includes a central processing unit (CPU) 201. The CPU 201 executes processing according to a program, such as an OS, the general application 101, and the bookbinding application 104, which is loaded from a program read-only memory (ROM) of a ROM 203 or a hard disk 211. As described above, the software configuration illustrated in FIG. 1 and processing in flow charts, which will be described in detail below, can be implemented. A random access memory (RAM) 202 functions as a main memory and a work area of the CPU 201.

A keyboard controller (KBC) 205 controls a key input from a keyboard (KB) 209 and a command input from a pointing device (not illustrated). A cathode ray tube (CRT) controller (CRTC) 206 controls display on a CRT display (display unit) 210. The display unit 210 is not limited to a CRT display. More specifically, a liquid crystal display (LCD) or a plasma display can be used as the display unit 210.

A disk controller (DKC) 207 controls access to/from the external memory 211 such as a hard disk (HD) and a floppy disk (FD). The external memory 211 stores various programs and data, such as a boot program, various applications, font data, a user file, a file to be edited, and a printer driver.

A printer controller (PRTC) 208 controls a transmission of a signal between the digital computer 100 and the printer 107. A network controller (NC) 212 is connected to a network and controls communication between the host computer 100 and other apparatuses on the network.

Before describing the details of the bookbinding application 104, a data format of a book file is described at first.

A book file has a 3-layer structure as a book made of paper sheets. More specifically, a top layer “book” corresponds to one book, and includes a definition of an attribute of the entire document. An intermediate layer “chapter” corresponds to a chapter of a paper book. Each “chapter” includes a definition of an attribute of each thereof. A bottom layer “page” corresponds to each page defined by the application program. Each page can include an attribute of each page.

One book can include a plurality of chapters, while one chapter can include a plurality of pages.

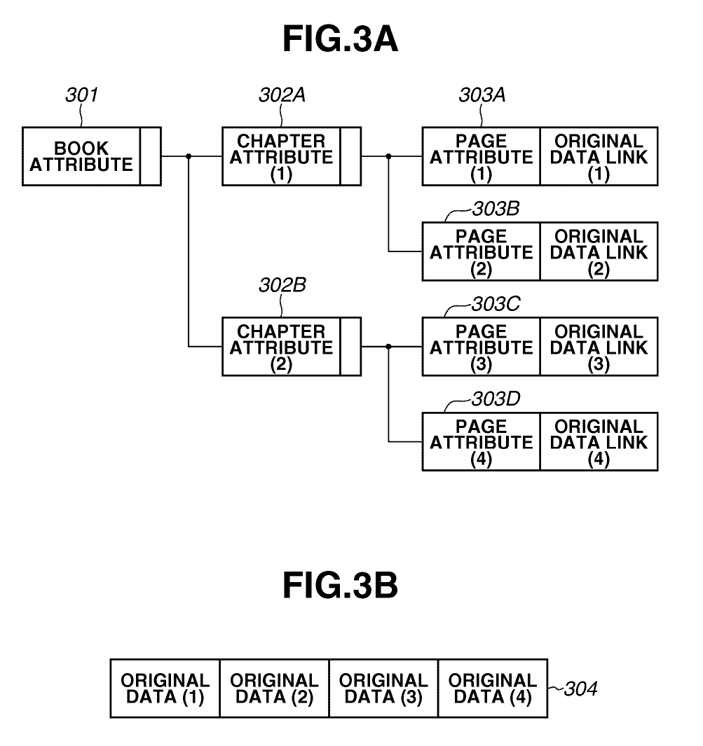

FIG. 3A illustrates an exemplary data format of a book file according to the present exemplary embodiment. Each book file according to the present exemplary embodiment has a hierarchical structure including a book, a chapter, and a page. Each of a book, chapter, and page of the book file is indicated with a node corresponding thereto. One book file includes one book. A book and a chapter are concepts that define the structure of the book. Accordingly, a book and a chapter include a defined attribute value and a link to a lower layer as an entity thereof.

A page includes data of each page output by the application program as its entity. Accordingly, a page includes its attribute value, the entity of a page of an original (hereinafter referred to as an “original page data”) and a link to each original page data.

A printed page to be output on a print sheet such as a paper medium may include a plurality of original pages. This structure is not indicated by the link but indicated as an attribute of each layer of book, chapter, and page.

Referring to FIG. 3A, a book 301 includes a definition of a book attribute. In addition, two chapters 302A and 302B are linked to the book attribute 301. The link indicates that the chapters 302A and 302B are included in the book attribute 301.

In addition, pages 303A and 303B are linked with the chapter 302A. The link indicates that the chapter 302A includes the pages 303A and 303B. Each of the pages 303A and 303B defines an attribute value of each page. Each of the pages 303A and 303B includes a link to original page data (1) and (2), which is an entity thereof. The link indicates the original data (1) and (2) of original page data 304 illustrated in FIG. 3B. The link also indicates that the entity of the pages 303A and 303B is the original page data (1) and (2).

Similarly, pages 303C and 303D are included in the chapter 302B. In addition, the chapter 302B includes a link to original page data (3) and (4), which is an entity thereof. The link indicates the original page data (3) and (4) of the original page data 304 (FIG. 3B). In addition, the link indicates that the entity of the pages 303C and 303D is the original page data (3) and (4).

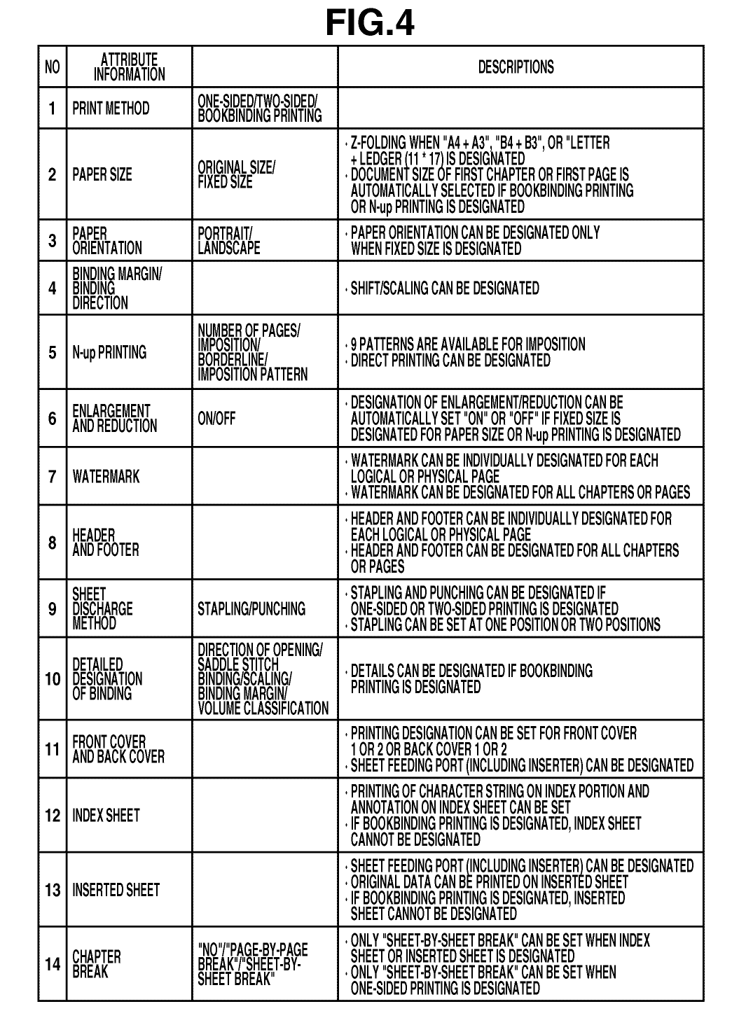

FIG. 4 illustrates an example of the book attribute 301 according to the present exemplary embodiment.

In general, an item that can be defined in duplication with a lower layer, an attribute value of the lower layer is prioritized over its upper layer. Accordingly, an item that is included only in the book attribute 301, a value defined in the book attribute 301 becomes valid for the entire book.

On the other hand, the item that can be defined in duplication with a lower layer can be used as a default value of a case where no definition is provided in the lower layer. In the present exemplary embodiment, each item illustrated in FIG. 4 does not always correspond to one item only. More specifically, each item illustrated in FIG. 4 may include a plurality of related items.

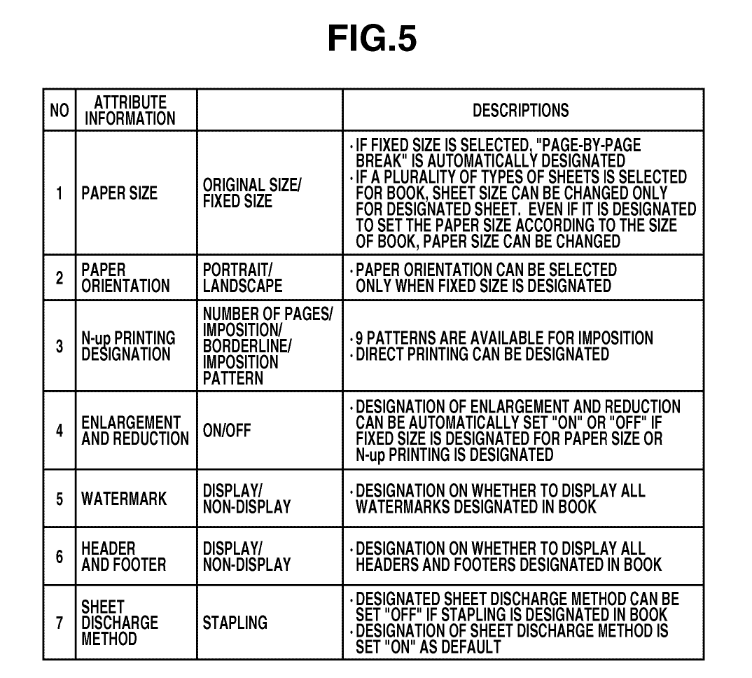

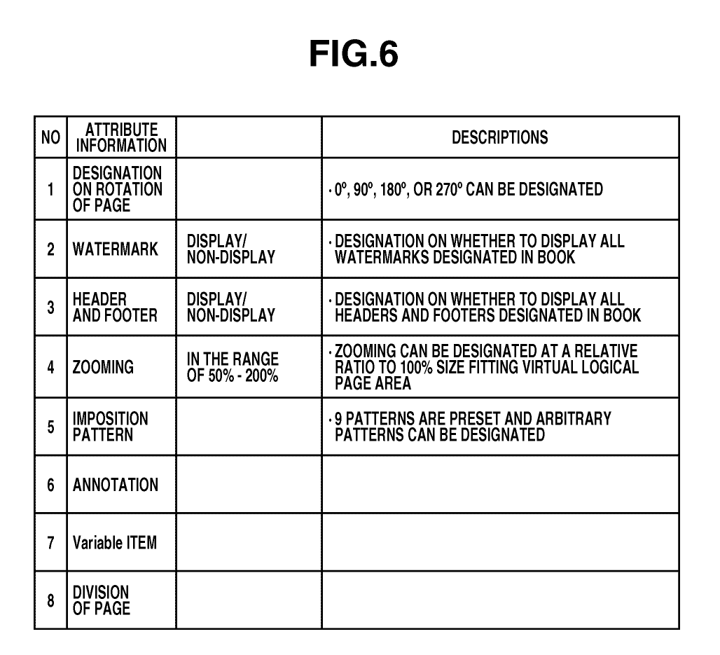

FIG. 5 illustrates an example of a chapter attribute according to the present exemplary embodiment. FIG. 6 illustrates an example of a page attribute according to the present exemplary embodiment. The relationship between the chapter attribute and the page attribute is similar to the relationship between the book attribute and an attribute of a lower layer.

Referring to FIG. 4, the following six items can be included in the book attribute 301 as unique items, namely, “print format”, “bookbinding details”, “front cover/back cover”, “index sheet”, “inserted sheet”, and “chapter break”. The items can be defined in a book.

For the attribute “print format”, a value of three setting items, namely, “one-sided printing”, “two-sided printing”, and “bookbinding printing”, can be designated.

“Bookbinding printing” is a method for printing in which a printed sheet bundle including a separately designated number of sheets is two-folded and bound into a book, for example. With respect to the attribute “bookbinding details”, if bookbinding is designated as a layout method, then an item such as the binding direction, the number of sheets of a bundle, and the like, can be designated.

The attribute “front cover/back cover” includes designation of using a front/back cover sheet and the content to be printed on the cover sheet if printing an electronic original file to be bound into a book.

The attribute “index sheet” includes designation of inserting a tabbed index sheet as a chapter break, which is separately set on the printing apparatus, and designation of the content to be printed on the index portion (tab). The attribute “index sheet” becomes enabled if an inserter having a function for inserting a sheet provided separately from the printing sheet at a desired position of a sheet bundle is provided to the printing apparatus or if a plurality of sheet feed cassettes can be used. The same applies to the attribute “inserted sheet”.

The attribute “inserted sheet” includes designation of inserting a sheet supplied from the inserter or the sheet feed cassette as a chapter break. Further, if it is designated to insert such a sheet, the attribute “inserted sheet” can include designation of a sheet feed source.

The attribute “chapter break” can designate, for a chapter break, whether to use a new sheet, whether to use a new page to be printed, or whether not to apply a particular operation for the chapter break. In the case of one-sided printing, the chapter break is set in the same format regardless of whether a new sheet or a new page to be printed is designated. On the other hand, in two-sided printing, if it is designated to use a new sheet for a chapter break, different two consecutive chapters are not printed on a same sheet while if it is designated to use a new page to be printed for a chapter break, different two consecutive chapters may be printed on the front side and the back side of one sheet, respectively.

In the chapter attribute illustrated in FIG. 5, no item unique to a chapter is defined and all items are the same as those defined in the book attribute. Accordingly, if the definition in the chapter attribute differs from the definition in the book attribute, then the parameter value defined in the chapter attribute is generally prioritized and used.

Only five items, such as the paper size, the paper orientation, designation of N-up printing, enlargement/reduction, and a sheet feeding method, are defined in common to the book attribute and the chapter attribute. Among the five common items, the attribute “N-up printing” designates the number of original pages to be printed on one page. For the type of the N-up layout, “1×1”, “1×2”, “2×2”, “3×3”, or “4×4”, for example, can be designated.

The attribute “sheet feeding method” designates whether to execute stapling on the fed sheet. The attribute “sheet feeding method” becomes enabled if the printing apparatus to be used includes the stapling function.

The attributes such as “page rotation”, “zooming”, “imposition”, “annotation”, “page division”, or the like can be defined uniquely to the page attribute illustrated in FIG. 6. The attribute “page rotation” designates the rotational angle of a page when an original page is imposed on a page to be printed. The attribute “zooming” designates a zooming (enlargement) ratio of the original page. The zooming ratio is a ratio of the size of the original page to the size of a virtual logical page area (100%).

A virtual logical page area refers to an area of one original page when the original page is imposed according to the layout designation such as N-up printing. For example, if the imposition “1×1” is designated, the virtual logical page area corresponds to the area of one printing page. On the other hand, if the imposition “1×2” is designated, the virtual logical page area corresponds to the area of one printing page whose each side is reduced to 70% of its original size.

The attributes “watermark” and “header/footer” are defined in common to the book, the chapter, and the page attributes. A “watermark” refers to information such as an image or a character string, which is designated separately from image data generated by an application and is printed in superimposition therewith.

Each of a header and footer is a watermark printed in a top margin or a bottom margin of each page. An item that can be designated by a variable, namely, information such as a page number or date and time, is provided to the header and the footer.

The contents that can be designated in the watermark attribute and the header/footer attribute are the same in the chapter attribute and the page attribute, but are different in the book attribute.

In the book attribute, the content of the watermark and the header and footer can be designated. In addition, in the book attribute, a method for printing the watermark and the header and footer can be designated in the entire book. On the other hand, in the chapter attribute and the page attribute, it can be designated whether to print the watermark or the header and footer set in the book attribute in the corresponding chapter or page.

A book file, which is an electronic original file whose structure is formed by the bookbinding application 104, has the structure and content described above.

Exemplary processing for generating a book file executed by the bookbinding application 104 and the electronic original writer 102 will be described in detail below. The book file generation processing is implemented as a part of an operation of the bookbinding application 104 for editing a book file.

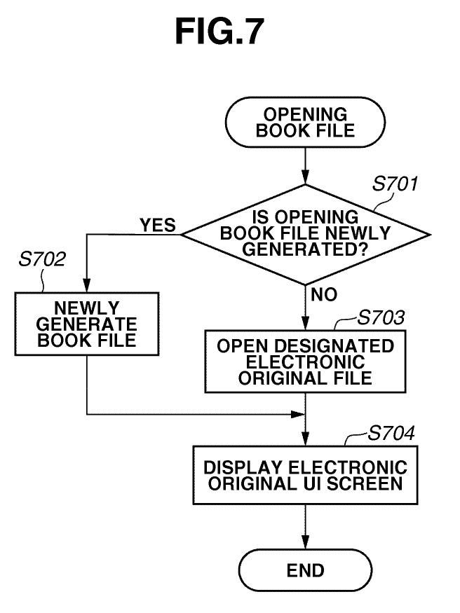

FIG. 7 is a flow chart illustrating an example of processing for opening a book file, which is performed by the bookbinding application 104 according to the present exemplary embodiment.

Referring to FIG. 7, in step S701, the bookbinding application 104 determines whether the book file to be opened is a book file to be newly generated. If it is determined that the book file to be opened is a book file to be newly generated (YES in step S701), then the processing advances to step S702. In step S702, the bookbinding application 104 generates a new book file that does not include a chapter.

In the example illustrated in FIGS. 3A and 3B, the book file to be newly generated includes a book node 301 only. More specifically, the book node 301 is a node of a book in which no link to a node of a chapter exists. For the book attribute, a set of attributes previously determined to be newly generated are applied.

In step S704, the bookbinding application 104 displays a UI screen for editing the new book file.

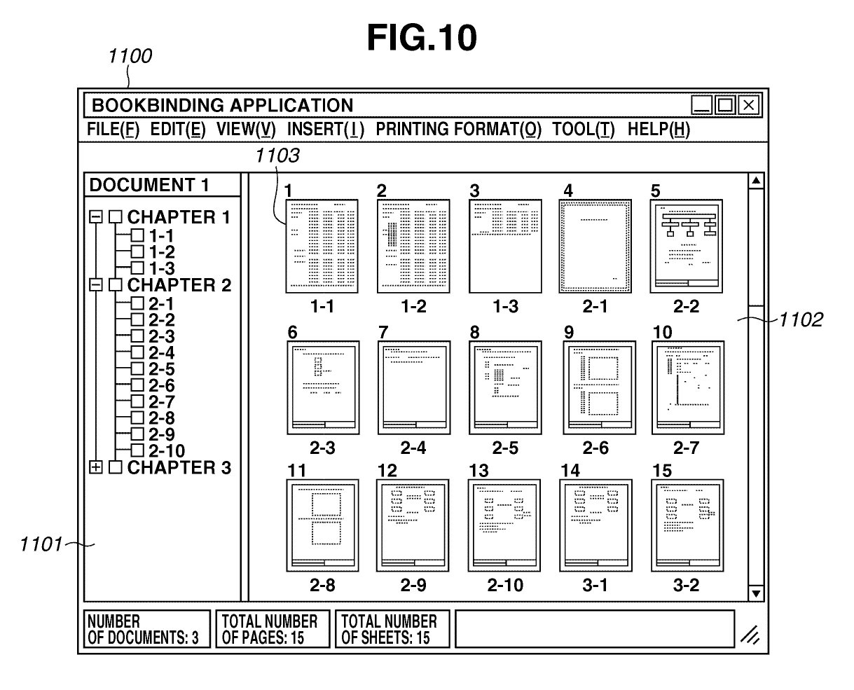

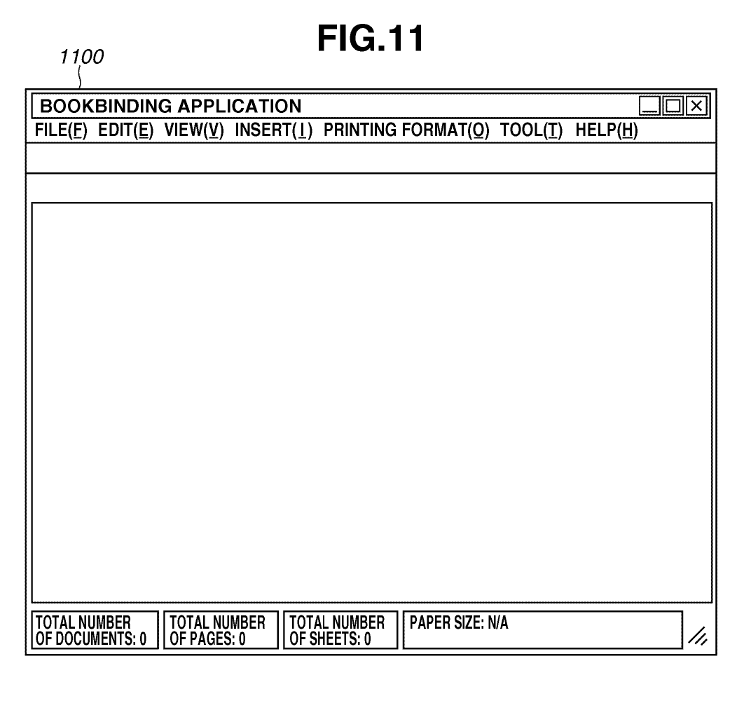

FIG. 11 illustrates an example of a UI screen 1100 which is displayed when a book file is newly generated according to the present exemplary embodiment. In the example illustrated in FIG. 10, the book file does not have any substantial content. Accordingly, no information is displayed on the UI screen 1100.

On the other hand, if it is determined that the book file to be opened is an existing book file (NO in step S701), then the processing advances to step S703. In step S703, the bookbinding application 104 opens the designated book file.

Then, the bookbinding application 104 displays the UI screen 1100 according to the structure, the attribute, and the content of the book file as illustrated in FIG. 10.

Referring to FIG. 10, the UI screen 1100 includes a tree structure field 1101 and a preview field 1102. The tree structure field 1101 indicates the structure of the book. The preview field 1102 displays settings of the sheet to be printed.

More specifically, the tree structure field 1101 displays a chapter of a book and a page of each chapter in a tree-like structure similar to the tree structure illustrated in FIG. 3A. In FIG. 10, an original page is displayed in the tree structure field 1101. The preview field 1102 displays the content of a page to be printed as a reduced image. An order of displaying the images is determined according to the structure of the book.

The bookbinding application 104 can add a new chapter to the opened book file. More specifically, the bookbinding application 104 adds application data converted by the electronic document writer 102 into an electronic document file of the book file as a new chapter. This function is referred to as an “electronic document importing function”.

The bookbinding application 104 can provide an entity to the new book file generated according to the processing illustrated in FIG. 7 by executing the electronic document importing function thereon. This function can be executed when the user drag-and-drops the application data on the screen illustrated in FIG. 10.

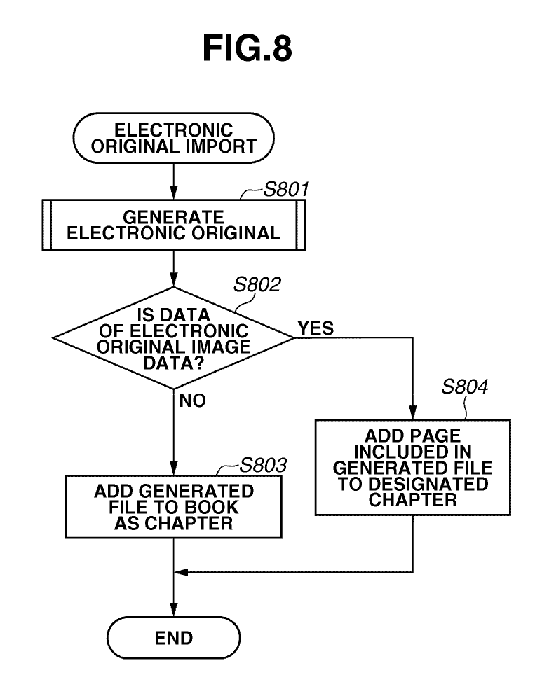

The electronic document importing processing will be described in detail below with reference to FIG. 8.

FIG. 8 is a flow chart illustrating exemplary processing for importing an electronic document file according to the present exemplary embodiment.

Referring to FIG. 8, in step S801, the bookbinding application 104 activates the application program that has generated the designated application data (a second original file). Further, the bookbinding application 104 designates the electronic document writer 102 as the device driver. Moreover, the bookbinding application 104 converts the application data into electronic document data by printing and outputting the application data by the electronic document writer 102.

When the application data is completely converted into the electronic document data, the processing advances to step S802. In step S802, the bookbinding application 104 determines whether the converted electronic document data is image data. If a Windows® OS is used, the determination in step S802 can be executed according to a file extension of the application data.

For example, if the file extension is “.bmp”, the converted electronic document data can be determined as bitmap data. If the file extension is “.jpg”, then the converted electronic document data can be determined as Joint Photographic Experts Group (JPEG) image data. Further, if the file extension is “.tiff”, then the converted electronic document data can be determined as tagged image file format (tiff) image data.

If the converted electronic document data is either of the above-described image data, then an electronic document file can be directly generated based on the image data without activating the application program. Accordingly, in this case, the processing in step S801 can be omitted.

If it is determined that the converted electronic document data is not image data (NO in step S802), then the processing advances to step S803. In step S803, the bookbinding application 104 imports the generated electronic document file by adding the file to the book of the currently opened book file (a first original file) as a new chapter.

In this case, the value of the book attribute is provided to a chapter attribute that is the same with the book attribute. In addition, a predetermined value is set to each of the other chapter attributes.

On the other hand, if it is determined that the converted electronic document data is image data (YES in step S802), then the processing advances to step S804. In step S804, the bookbinding application 104 imports the data by basically, not adding a new chapter and adding each original page included in the generated electronic document file to the designated chapter.

However, if the book file is a newly generated file, a new chapter is generated and the bookbinding application 104 adds each page of the electronic document file to the newly generated chapter as pages thereof.

In the present exemplary embodiment, a page attribute that is the same with the attribute of an upper layer is provided with the attribute value of the upper layer. On the other hand, the page attribute that has been defined in the application data and included in the electronic document file, the value of the page attribute defined in the application data is provided thereto. If N-up printing, for example, is designated in the application data, the attribute value of the designated N-up printing is provided to the electronic document file.

A new book file is generated or a new chapter is added in the above-described manner. However, in the present exemplary embodiment, it can be selected whether to prioritize the attribute value defined in the lower layer as will be described in detail below.

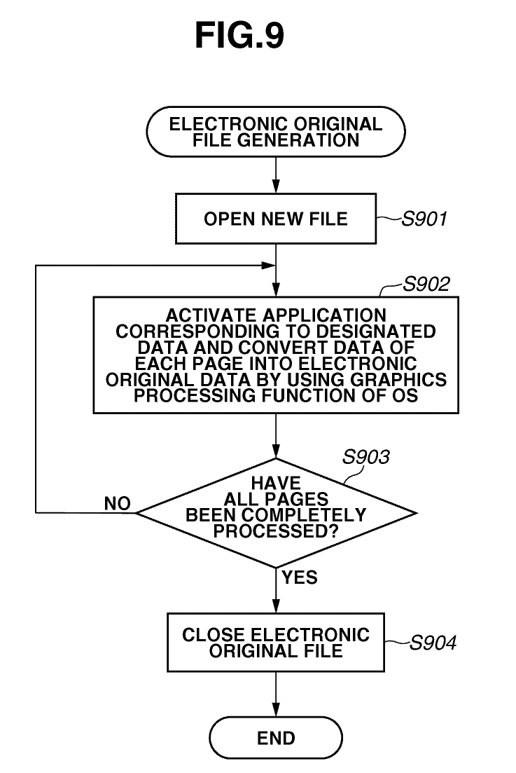

FIG. 9 is a flow chart illustrating exemplary processing for generating an electronic document file executed by the electronic original writer 102 in step S801 (FIG. 8) according to the present exemplary embodiment.

Referring to FIG. 9, in step S901, the bookbinding application 104 generates a new electronic document file and opens the newly generated electronic document file.

In step S902, the bookbinding application 104 activates an application program corresponding to the designated application data. In addition, the bookbinding application 104 uses the electronic document writer 102 as the device driver and transmits an output command to the output module of the OS.

Furthermore, in step S902, the output module converts the received output command into data of the electronic document format by using the electronic document writer 102. Moreover, the output module outputs the converted data. The destination to output the converted data is the file opened in step S901.

In step S903, the bookbinding application 104 determines whether all the designated data has been completely converted. If it is determined that the conversion has not been completed (NO in step S903), then the processing returns to step S902. On the other hand, if it is determined that the conversion has been completed (YES in step S903), then the processing advances to step S904. In step S904, the bookbinding application 104 closes the electronic document file.

The electronic document file generated by the electronic document writer 102 is a file including the entity of the original page data illustrated in FIG. 3B.

The bookbinding application 104 can generate a book file based on the application data in the above-described manner.

The following editing operations can be executed on a chapter and a page of the book file generated in the above-described manner.
(1) Adding a new chapter or page
(2) Deletion
(3) Copying
(4) Cutting
(5) Pasting
(6) Moving
(7) Renaming of chapter
(8) Changing the page number or renaming the page name
(9) Inserting a front cover sheet
(10) Inserting a sheet
(11) Inserting an index sheet
(12) Designating the page layout to each original page

In addition to the operations described above, an operation for canceling the once designated editing operation and an operation for re-designating the once canceled operation can be executed. By executing the above-described editing functions, editing operations, such as integrating with a plurality of book files, rearranging a chapter or a page within a book file, deleting a chapter or a page from a book file, changing a layout of an original page, and inserting a sheet or an index sheet, can be implemented.

After the above-described operation is executed, the result of the operation is applied to the attribute illustrated in FIGS. 4 through 6 or to the structure of the book file. For example, if a blank page is newly added, the blank page is inserted at a designated portion of the chapter. The inserted blank page is handled as an original page.

On the other hand, if the layout of an original page is changed, the content of the change is applied to the attribute, such as the print format, N-up printing, the front cover sheet/spine/back cover, the index sheet, the inserted sheet, and the chapter break.

The display and operation executed during an editing operation according to the present exemplary embodiment will be described in detail below.

The book file that is generated and edited in the above-described manner is intended to be finally printed or output. When the user selects a file menu on the UI screen 1100 of the bookbinding application illustrated in FIG. 10 and selects “print” from the file menu, the book file is printed and output by a designated output device.

In this case, at first, the bookbinding application 104 generates a job ticket based on the currently opened book file and transmits the generated job ticket to the electronic document despooler 105. After receiving the job ticket, the electronic document despooler 105 converts the received job ticket into an output command of the OS, such as a GDI command of Windows®. The electronic document despooler 105 further transmits the converted command to the output module such as a GDI.

The output module generates a command that complies with the type of the device by using a designated printer driver 106 and transmits the generated command to the output device.

In the present exemplary embodiment, a job ticket is data having a structure in which an original page is a minimum unit. The structure of the job ticket defines the layout of the original page on the sheet. In addition, one job ticket is issued for each job.

Therefore, in the job ticket, a document node exists in the top layer which defines the attribute of the entire document, such as the attribute “one-sided printing/two-sided printing”. Below the document node, a sheet node exists which includes an attribute such as an identifier of a sheet to be used and designation of a sheet feed port of the printer. Each sheet node includes a node of a sheet to be printed on a paper sheet. One “sheet” included in the sheet node corresponds to one paper sheet.

Each “sheet” includes the attribute of a page to be printed (physical page). If one-sided printing is designated, one sheet includes one physical page. On the other hand, if two-sided printing is designated, then one sheet includes two physical pages. Each physical page includes an original page to be provided thereon. In addition, the layout of the original page is included in the attribute of the physical page.

The electronic document despooler 105 converts the job ticket into the output command to the output module.

The document processing system according to the present exemplary embodiment has the configuration described above. The document processing system according to the present exemplary embodiment is a stand-alone type document processing system. If a server-client type document processing system, which is an expansion of the stand-alone type system, can generate and edit a file by a substantially similar configuration and by executing a substantially similar method. In this case, however, a server manages a book file or controls the print processing.

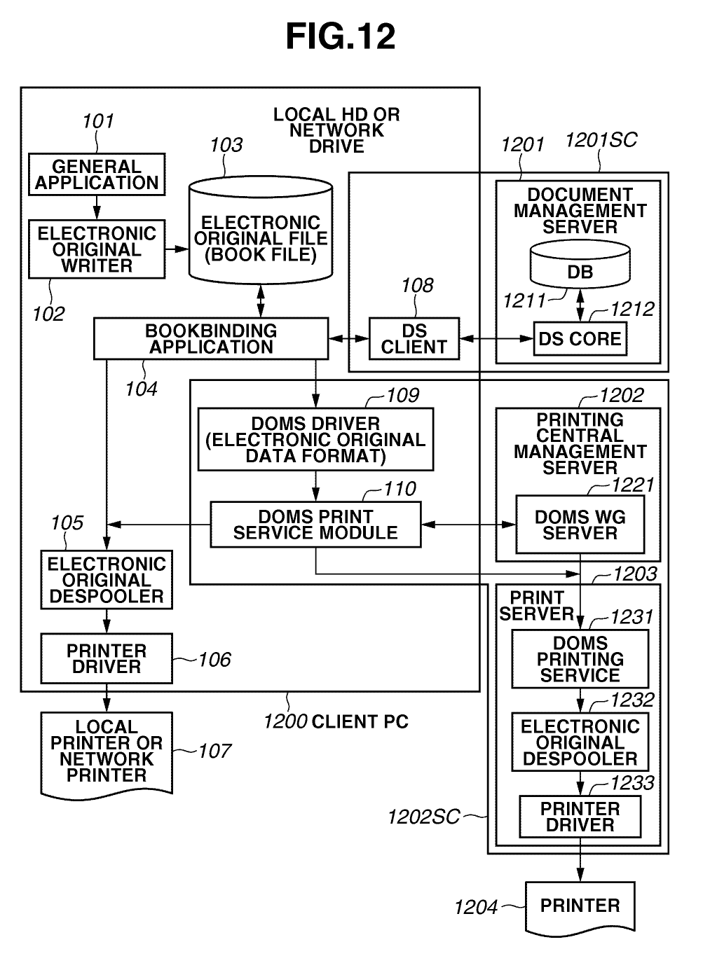

FIG. 12 illustrates an exemplary configuration of a server-client type document processing system. A client document processing system 1200 has a configuration in which a document output management service (DOMS) driver 109, which is a client module, a DOMS print service module 110, and a document service (DS) client module 108 are added to the configuration of the stand-alone document processing system.

To the client document processing system 1200, a document management server 1201, a printing central management server 1202, and a print server 1203 are connected. The document management server 1201, the printing central management server 1202, and the print server 1203 are connected to the document management server 1201 via an ordinary network. In a client-server system, if a server functions as a client at the same time, the document management server 1201, the printing central management server 1202, and the print server 1203 are connected via an inter-process communication in which a communication between networks is simulated.

In the example illustrated in FIG. 12, both the printing central management server 1202 and the print server 1203 are connected to a client personal computer (PC). However, the configuration is not limited to this. That is, the configuration can be arranged such that one of the printing central management server 1202 and the print server 1203 only exists on a network.

If a document management server is connected to the client, a document management server-client system 1201SC, which includes the client module, is added to the stand-alone type document management system. On the other hand, if the printing central management server 1202 is connected to the client, a printing management server-client system 1202SC, which includes the client module, is added to the stand-alone type document management system.

The document management server 1201 is a server that stores a book file generated and edited by the bookbinding application 104. In the case of managing a book file with the document management server 1201, the book file is stored in a database 1211 of the document management server 1201, instead of or in addition to a local HD in a client PC. Storing and reading of a book file performed between the bookbinding application 104 and the document management server 1201 are performed via the DS client 108 and a DS core 1212.

The printing central management server 1202 is a server that manages printing of a book file stored in the client document processing system 1200 or in the document management server 1201. A print request generated by the client PC is sent to a DOMS WG server module 1221 of the printing central management server 1202 via the DOMS driver 109 and the DOMS print service module 110. The printing central management server 1202, if printing is performed by a printer connected to the client PC, transfers electronic original data to the electronic original despooler 105 via the DOMS print service module 110.

Meanwhile, if printing is performed by the print server 1203, the printing central management server 1202 sends electronic original data to the DOMS print service module 1231 of the print server 1203. The printing central management server 1202 performs security checking concerning an authority of a user who has generated a print request of the stored book file and stores a log file of the print processing, for example. As described above, the document processing system can be implemented in a stand-alone system or in a client-server system.

As described above, when a book file is opened by the bookbinding application 104, the UI screen 1100 illustrated in FIG. 10 is displayed. In the tree portion 1101, a tree indicating a structure of the opened book (hereinafter referred to as a “target book”) is displayed. In the print preview portion 1102, three display methods are provided according to a specification by a user. First, a mode called an original view, in which an original page is displayed as it is, is provided. In the original view mode, a content of the original page included in the target book is displayed in a reduced state. Note that a layout is not reflected to the display in the preview portion 1102.

Secondly, a print view mode is provided. In the print view mode, an original page is displayed in the preview portion 1102 in a state in which a layout of an original page is reflected.

Thirdly, a simple print view mode is provided. In the simple print view mode, a content of each original page is not reflected in the display in the preview portion 1102, and only the layout of the original page is reflected.

Now, before describing characteristic features of an exemplary embodiment of the present invention, an exemplary configuration of the document processing system including the host computer 100, which is an example of the information processing apparatus of the present invention, and the printer 107 will be described in detail below.

The exemplary configuration of the host computer 100 (hereinafter may also be simply referred to as a “client”) is as described above with reference to FIG. 2. Therefore, units and components of the host computer 100 similar to those described above are provided with the same numerals and symbols. Accordingly, the description thereof will not be repeated here.

In addition, a local printer connected to the client or the printer 1204 (FIG. 12), which is connected to the server, can be used as the printer 107.

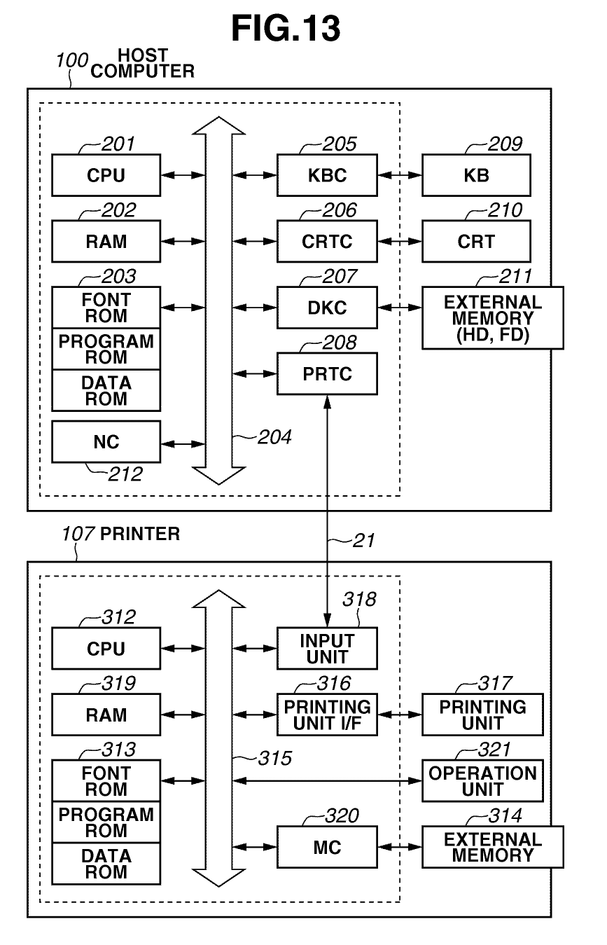

FIG. 13 illustrates an exemplary configuration of the document processing system according to the present exemplary embodiment. The present invention can be implemented in a system including one apparatus only or a plurality of apparatuses or in a system in which the apparatus(es) thereof is connected to an external apparatus via a network such as a local area network (LAN) or a wide area network (WAN) to execute characteristic processing, if the system is capable of implementing functions according to the present exemplary embodiment.

In the present exemplary embodiment, the host computer 100 has a configuration similar to that described above with reference to FIG. 2. Accordingly, the description thereof will not be repeated here.

Referring to FIG. 13, the printer 107 is controlled by a CPU 12. The CPU 12 outputs an image signal, as output information, to a printing unit 17, which is connected to a system bus 15, based on a control program stored on a program Rom of a ROM 13 or a control program loaded from an external memory 14 on a RAM 19. The program ROM of the ROM 13 stores a control program executed by the CPU 12.

A font ROM of the ROM 13 stores font data used in generating the above-described output information. When a printer that does not include an external memory 14 such as a hard disk is used, a data ROM of the ROM 13 stores information utilized on the host computer 100.

The CPU 12 can communicate with the host computer 100 via an input unit 18. The CPU 12 can notify various pieces of information about the printer 107 to the host computer 100.

A RAM 19 functions as a main memory and a work area of the CPU 12. A memory capacity of the RAM 19 can be expanded with an optional RAM, which can be connected to an expansion port (not illustrated). The RAM 19 is used as an output information rasterization area, an environmental data storage area, and a non-volatile random access memory (NVRAM).

Access to/from the external memory 14, which is an HD or an integrated circuit (IC) card, is controlled by a memory controller (MC) 20. The external memory 14, which is connected as an optional memory, stores the font data, an emulation program, form data, or the like.

An operation panel (i.e., operation unit) 21 includes components, such as operation switches which implement various operations on the printer 107 and a light-emitting diode (LED) indicator.

The number of the external memory 14 is not limited to one. More specifically, a plurality of external memories 14 may be provided and a plurality of optional font cards, in addition to the built-in font, and a plurality of external memories storing a program for interpreting a printer control language (PCL) of different language systems can be connected. In addition, an NVRAM (not illustrated) may be provided to store printer mode setting information from the operation unit 21.

In the present exemplary embodiment, the host computer 100 includes the file, application, despooler, and driver, which are described above with reference to FIG. 1. In addition, the electronic original file 103 is generated by processing a document file (application data) generated by the general application 101 on the electronic original writer 102.

As described above, the electronic original file 103 can be opened by the bookbinding application 104. In opening the electronic original file 103, the bookbinding application 104 displays the operation screen illustrated in FIG. 10 on the display unit 210.

The bookbinding application 104 greatly differs from the general application 101 in a point that the bookbinding application 104 has a print setting function, which is generally provided by the printer driver 106.

Because the bookbinding application 104 includes the print setting function as described above, the bookbinding application 104 can execute a setting of a function of the printer 107, such as a stapling function and a punching function, on the electronic original file 103, in addition to executing thereon a function for rearranging the page order of the document and an editing function such as a duplication (copy) function and a deletion function. Accordingly, it is enabled for the user to execute printing on a designated printer.

In the present exemplary embodiment, the bookbinding application 104 may be also referred to as a “print setting application”.

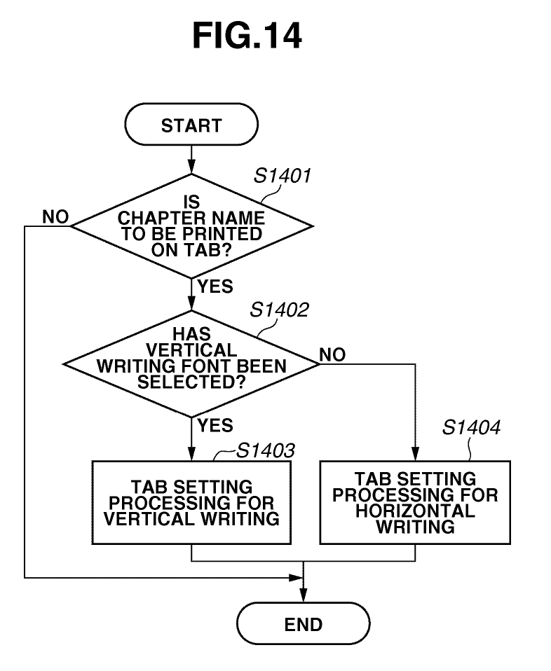

FIG. 14 is a flow chart illustrating an example of processing for instructing insertion of a cover sheet or an index sheet and executing a setting for printing a name of a chapter in a tab of the index sheet according to the present exemplary embodiment. The processing illustrated in the flow chart of FIG. 14 is executed by the bookbinding application 104 by using a “sheet insertion setting” function of the bookbinding application 104.

The sheet insertion setting function is one of print setting functions of the bookbinding application 104 provided uniquely thereto, which the general application 101 does not include. In the processing according to the present exemplary embodiment, an index sheet is inserted in a chapter break.

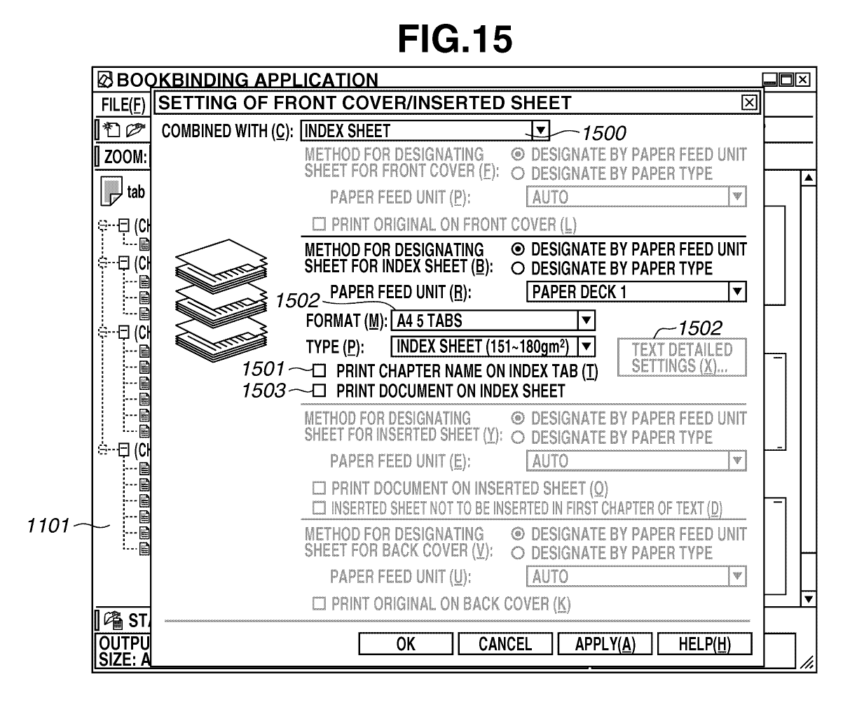

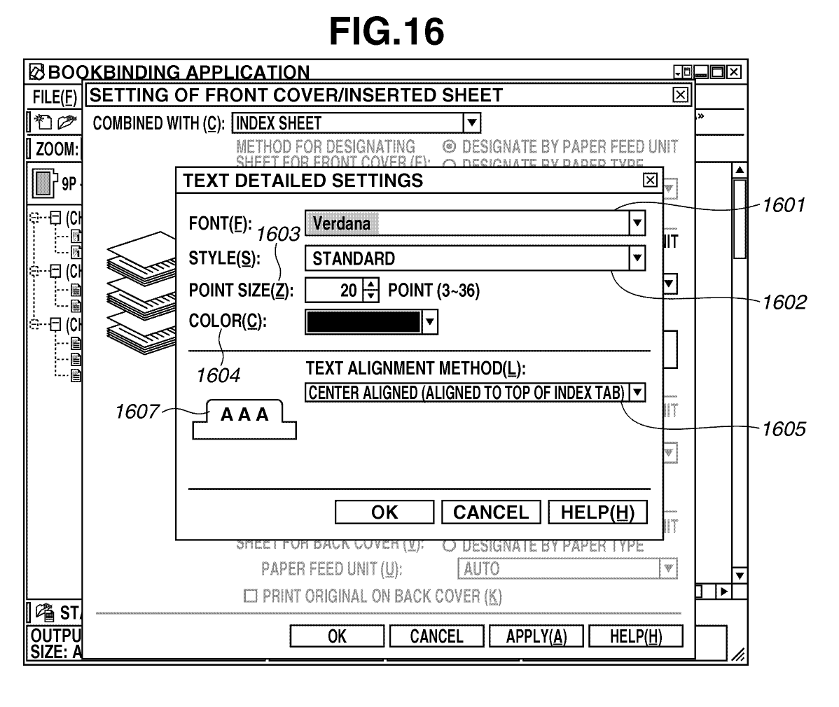

Before describing the processing in the flow chart of FIG. 14, an example of the sheet insertion setting processing will be described in detail below with reference to FIGS. 15 and 16.

FIG. 15 illustrates an example of a sheet insertion setting window displayed by the bookbinding application 104 according to the present exemplary embodiment.

Referring to FIG. 15, an area 1500 is an area for instructing a combination of sheets to be inserted. In the present exemplary embodiment, the user has instructed insertion of an index sheet. Accordingly, a setting value “index sheet” is displayed in the area 1500. The user can set a value other than “index sheet”, such as “front cover sheet”, “inserted sheet”, or “back cover sheet”. Alternatively, the user can set a setting value that is a combination of all of or a part of or either one of the alternatives (“index sheet”, “front cover sheet”, “inserted sheet”, and “back cover sheet”)

The setting value designated by the user via the dialog box (“index sheet”, “front cover sheet”, “inserted sheet”, and/or “back cover sheet”) does not exist as actual document data within the electronic original file 103. Accordingly, the setting value is managed as print setting information within the electronic original file 103.

Accordingly, the user can insert or delete an index sheet by merely changing the print setting via the dialog box (by not checking the check box or changing the tag). With this configuration, the present exemplary embodiment can effectively increase the operability of the user.

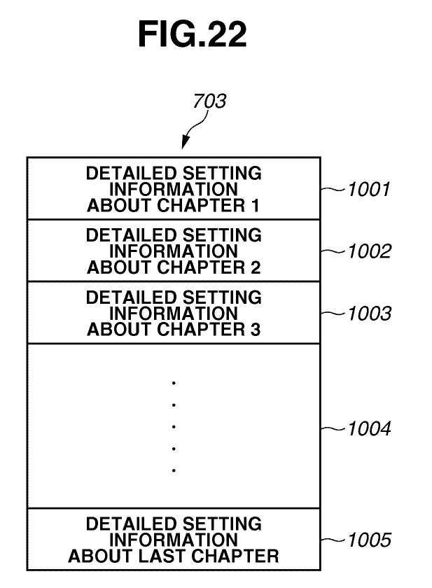

In the example illustrated in FIG. 15, in a check box 1501, the user has selected a setting “print chapter name on index tab”. Accordingly, the user can designate printing of a name of each chapter displayed in the tree field 1101 (FIG. 10), which is previously stored as setting information of each chapter (FIG. 22), on a tab of an index sheet inserted for each chapter.

In addition, the user can print a previously generated document (a document generated as a document to be printed on an index sheet) on the index sheet. More specifically, the user can print an original page on an index sheet by checking a “print original on index sheet” check box 1503.

FIG. 16 illustrates an example of a display on a window, which is opened when the user selects a “text detailed settings” field 1502 (FIG. 15) displayed by the bookbinding application 104. More specifically, the window illustrated in FIG. 16 is a window for executing a detailed setting of a text string (chapter name) to be printed on an index sheet.

The user can select the font or the size of the text to be used in printing a chapter name in the tab portion via the window illustrated in FIG. 16. In addition, candidates displayed in a layout designation field are automatically changed according to the election by the user via a font designation field of the window illustrated in FIG. 16 (i.e., according to which of a horizontal-line font or a vertical-line font the user selects).

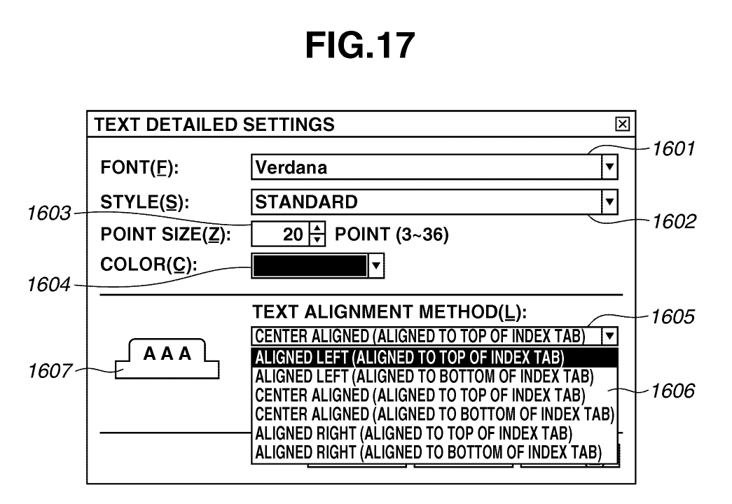

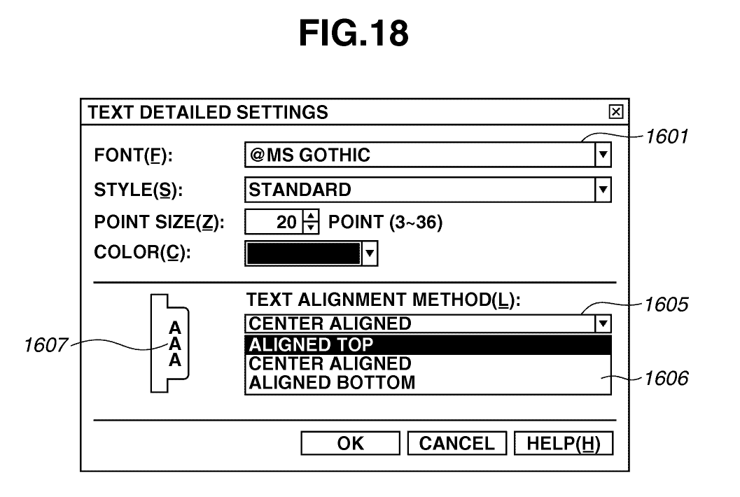

If the user selects the horizontal-line font, the window is changed to a window illustrated in FIG. 17 while if the user selects the vertical-line font, the window is changed to a window illustrated in FIG. 18. Each of FIGS. 17 and 18 is an enlarged view of the windows.

The bookbinding application 104, which is a print control program according to the present exemplary embodiment, provides a tab setting screen illustrated in FIG. 16. Accordingly, the user can easily set a character string to be printed on a tabbed sheet (a tab portion of an index sheet) inserted into the document. Therefore, according to the present exemplary embodiment, the user does not need to generate data to be printed on an index sheet as a document page, which is necessary in a conventional method.

In addition, if the user desires to change the insertion position of the index sheet into the document, it is necessary for the user only to change the page position of the index sheet via a page preview screen of the bookbinding application 104. Accordingly, the user can easily operate the system.

In addition, in adding an index sheet, the user only needs to instruct addition of an index sheet. Accordingly, the present exemplary embodiment can greatly increase the operability of the user.

In the present exemplary embodiment, because a horizontal-line font “MS Mincho” has been selected, the user can select a desired layout from among alternatives displayed in a field 1606 illustrated in FIG. 17.

Referring to FIG. 17, the user has selected “left-align (aligned to top of index tab)” in a field 1605. Accordingly, the chapter name is printed in a layout in which the character string is aligned to the left edge of the tab and the tab of the index sheet is oriented upward.

In addition, if the user selects “left-align (aligned to bottom of index tab)”, the chapter name is printed in a layout in which the character string is aligned to the left edge of the tab and the tab of the index sheet is oriented downward. As described above, if the user selects the horizontal-line font, it is enabled to execute printing in a state where the tab is oriented either upward or downward.

In addition, the window illustrated in FIG. 16 includes a style designation area 1602, a font size setting area 1603, a font color setting area 1604, and a layout selection field 1605. The field 1605 includes a layout selection menu 1606 (FIG. 17). In the window illustrated in FIG. 16, the user has selected a standard style via the area 1602. Furthermore, the font size “10 point” and the layout “center-align (aligned to top of index tab)” have been selected. A field 1607 displays the format of the character string to be actually printed in the tab (in the example illustrated in FIG. 16, the left-align format).

FIG. 18 illustrates an example of a window displaying a state in which the user has selected a vertical-line font via a window for executing a detailed setting of a character string to be printed in the tab of an index sheet according to the present exemplary embodiment.

In the example illustrated in FIG. 18, the user has selected a vertical-line font “@MS Gothic” via the font designation area 1601. In this case, the user can select a desired layout from among layout candidates “aligned top”, “center aligned”, and “aligned bottom”, which are displayed in the layout setting menu 1606.

Because the layout “aligned top” is selected in the example illustrated in FIG. 18, the field 1606 displays the set layout “aligned top”. In addition, in the field 1607, it is displayed that the setting has been executed for printing the chapter name in the tab top-align layout in which the tab of the index sheet is oriented rightward.

In the example illustrated in FIG. 18, the user can select either one of the layouts “aligned top”, “center aligned”, or “aligned bottom” as the layout of the index sheet tab. However, the present exemplary embodiment is not limited to this.

More specifically, it is also useful if a field for designating an orientation of opening of the print product (“left-open” or “right-open”) as the print setting executed by using the bookbinding application 104.

In this case, if “left-open” is selected as the setting of the binding direction, the user can select the layout as illustrated in FIG. 18. On the other hand, if “right-open” is selected, the user can select either “aligned top (aligned to left of index tab)”, “center aligned (aligned to left of index tab)”, or “aligned bottom (aligned to left of index tab)”.

If the layout “aligned to left of index tab” is selected, the chapter name is printed in the layout in which the index sheet tab is oriented leftward.

The processing illustrated in the flow chart of FIG. 14, which is executed based on the above-described configuration, will be described in detail below.

Referring to FIG. 14, in step S1401, the bookbinding application 104 determines whether the setting for printing the chapter name in the tab has been executed. The determination in step S1401 is executed based on whether the check box 1501 (FIG. 15) has been checked.

If it is determined that the check box 1501 is checked (if it is determined that the setting for printing the chapter name in the tab has been executed) (YES in step S1401), then the processing advances to step S1402.

In step S1402, the user selects a font to be used in printing the name of the chapter or a chapter number of the chapter in the tab. More specifically, in step S1402, the bookbinding application 104 determines whether the user has selected the vertical-line font. The determination in step S1402 is executed based on the type of the selected font.

If it is determined that the user has selected the vertical-line font (YES in step S1403), then the processing advances to step S1403. In step S1403, the bookbinding application 104 performs processing for executing a setting of the tab portion for printing the set vertical-line font therein.

In the processing for executing the setting of the tab portion for printing the set vertical-line font in the tab in step S1403, as illustrated in the example in FIG. 18, the bookbinding application 104 provides a display screen in which the style, size, color, and alignment method of the character font are set. Furthermore, the bookbinding application 104 executes control for displaying the screen on the display unit 210 via the OS.

In the present exemplary embodiment, as described above, it is also useful if the bookbinding application 104 further determines the binding direction (which of “right-open” and “left-open” has been designated). In this case, the bookbinding application 104 can change the candidates of layouts of the index sheet tab according to the set binding direction.

In addition, if it is determined that the horizontal-line font is selected (NO in step S1402), then the processing advances to step S1404. In step S1404, the bookbinding application 104 performs processing for executing a setting of the tab portion for printing using the horizontal-line font.

In the processing for executing the setting of the tab portion for printing the set horizontal-line font in the tab in step S1404, as illustrated in the example in FIG. 16, the bookbinding application 104 provides a display screen in which the style, size, color, and alignment method of the character font are set. Furthermore, the bookbinding application 104 executes control for displaying the screen on the display unit 210 via the OS.

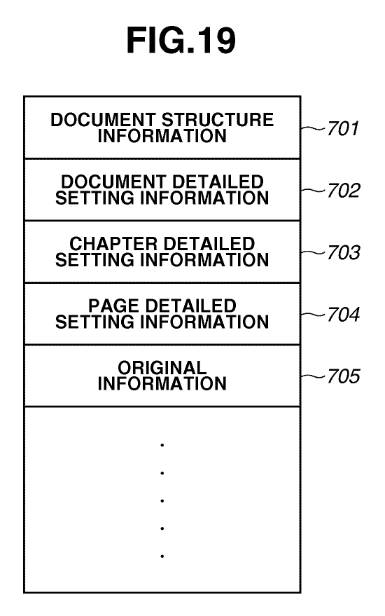

FIG. 19 illustrates an example of a structure of data of a document file processed by the general application 101 according to the present exemplary embodiment. The document file corresponds to the electronic original file 103 illustrated in FIG. 1. The document file (the electronic original file 103) is stored on the external memory 211 illustrated in FIG. 13. However, the present exemplary embodiment is not limited to this. More specifically, it is also useful if the document file (the electronic original file 103) is stored on the database 1211 of the document management server 1201 (FIG. 12).

Referring to FIG. 19, document structure information 701 stores information about the structure of a document displayed in the tree view field 1101 of the application operation screen illustrated in FIG. 10.

A document detailed setting information storage area 702 stores information that can be set to the entire document. A chapter detailed setting information storage area 703 stores information that can be set to each chapter.

A page detailed setting information storage area 704 stores information that can be set to each page. An original information storage area 705 stores drawing information about each original page. More specifically, the area 705 stores information to be displayed in the print preview field 1102, (a right portion of the example illustrated in FIG. 10) in the unit of a page.

The document file illustrated in FIG. 19 includes information necessary for the document in addition to the above-described information. However, the other necessary information will not be described in detail here.

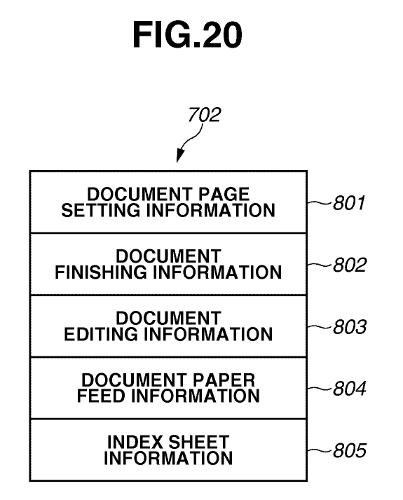

FIG. 20 illustrates an example of a structure of data stored in the document detailed setting information storage area 702 illustrated in FIG. 19.

Referring to FIG. 20, the document detailed setting information storage area 702 includes an original page setting information storage area 801, a document finishing information storage area 802, a document editing information storage area 803, a document paper feed information storage area 804, and an index sheet information storage area 805. The information stored in each of the areas 801 through 805 is stored as the document detailed setting information 702.

If the user executes the setting of the index sheet via the operation screen illustrated in FIG. 15, then the setting information is added to the index sheet information 805.

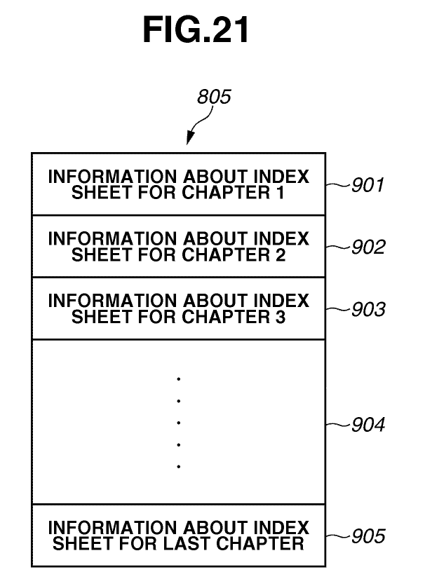

FIG. 21 illustrates an example of the information stored in the index sheet information storage area 805. Referring to FIG. 21, first chapter index sheet information 901 through last chapter index sheet information 905 is stored in each of serially provided areas in ascending order of the chapter number of the corresponding chapter.

If the user has executed a setting for using an index sheet as illustrated in FIG. 15, then the index sheet is to be inserted in a top of each chapter. In this case, the areas storing chapter index sheet information in the number equivalent to the number of chapters are provided.

FIG. 22 illustrates an example of a structure of data stored in the chapter detailed setting information storage area 703 illustrated in FIG. 19. In the example illustrated in FIG. 22, detailed setting information corresponding to each chapter from the first chapter to the last chapter (information 1001 through 1005) is stored.

The name of the chapter (at a timing immediately after the data is imported, the file name or the name of the chapter renewed by the user after the import) to be printed in the tab of the index sheet is included in each chapter detailed setting information.

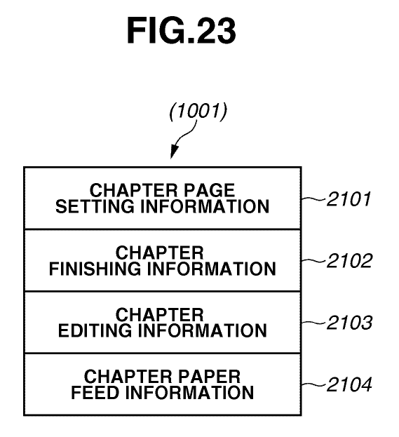

FIG. 23 illustrates an example of a structure of data of each of chapter detailed setting information 1001 through 1005 illustrated in FIG. 22. Referring to FIG. 23, a chapter page setting information storage area 2101 stores a chapter name.

In addition, each chapter setting information includes chapter finishing information 2102, chapter editing information 2103, and chapter paper feed information 2104.

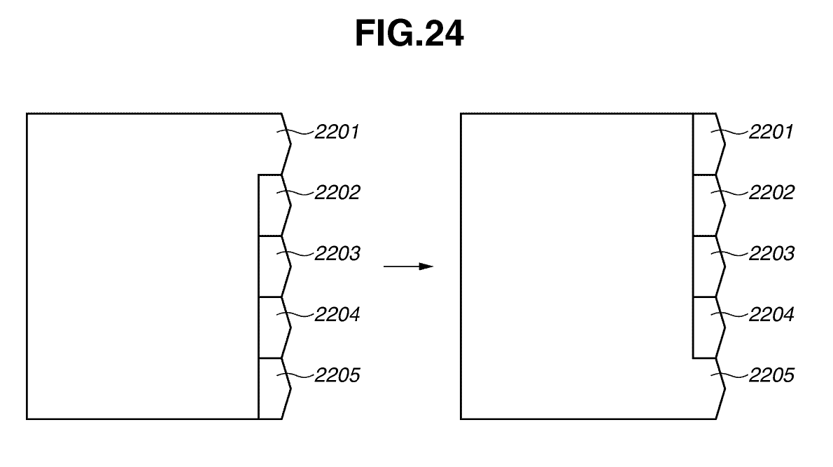

FIG. 24 illustrates an example of a state in which detailed editing of an index sheet is executed after executing the index sheet insertion setting illustrated in FIG. 15. Referring to FIG. 24, the editing screen (window) displays a state in which all index sheets (five sheets in the example illustrated in FIG. 24) are stacked. The user can designate an index sheet tab to be edited by using a mouse pointer of a mouse (pointing device).

By clicking the mouse to designate the index sheet tab displayed on the screen, the designated index sheet is displayed in the first page of the chapter. At this timing, the index sheet page data becomes editable.

In the initial screen illustrated in the left portion of FIG. 24, the index sheet of the first chapter is editable. Accordingly, the index sheet including a tab 2201 is active. Thus, the index sheet becomes editable.

If the user clicks a tab 2205 in this state, then the index sheet including the tab 2205 (the fifth index sheet) is displayed on the top of the display field as illustrated in the right portion of FIG. 24. Thus, the index sheet becomes editable. The index sheet tab and the content of the index sheet that have become editable (active) in the above-described manner can be edited by the user.

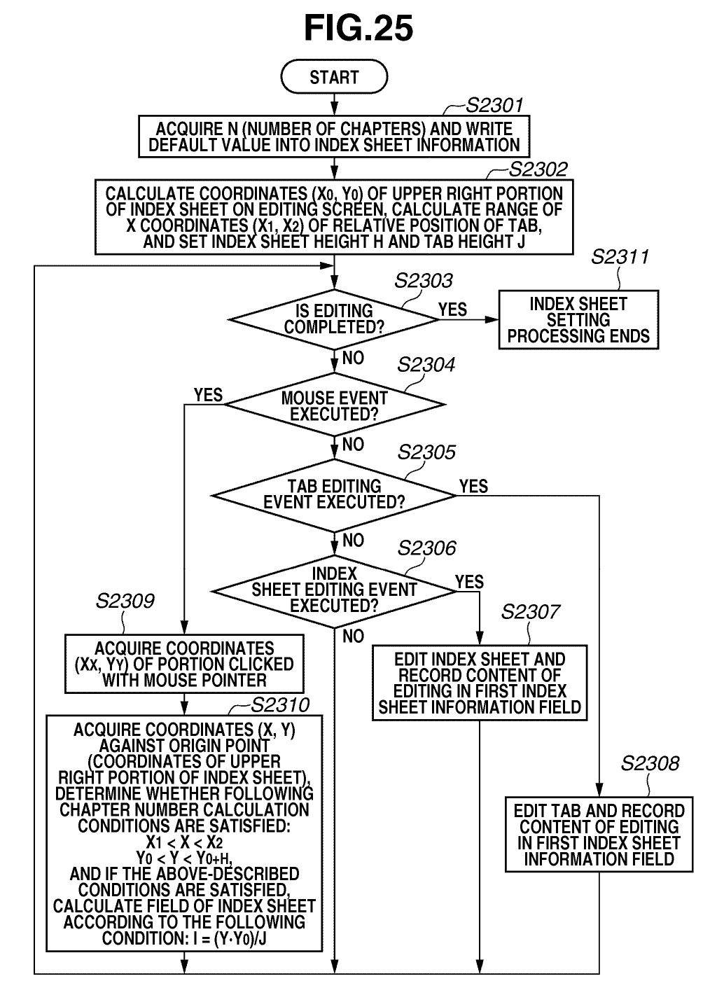

FIG. 25 is a flow chart illustrating an example of processing executed by the general application 101 for executing a setting of an index sheet and an example of preview display processing executed in the document processing system according to the present exemplary embodiment.

If the user has executed a setting of the index sheet via the index sheet insertion setting dialog (FIG. 15), the general application 101 secures an area for recording the index information whose number of pieces is equivalent to the number of the chapters included in the document as illustrated in FIG. 21.

Referring to FIG. 25, in step S2301, if an index sheet is set for the first time by executing the current processing, the general application 101 secures an index sheet information area for each chapter in the number equivalent to the number of the chapters (N) as illustrated in FIG. 21. Furthermore, an index sheet information default value is written therein.

After executing the index sheet editing operation, in step S2302, the general application 101 calculates information for acquiring effective coordinates for the tab area of the index sheet. In the present exemplary embodiment, the general application 101 previously calculates X coordinates of the position of the tab (X1, X2), the index sheet height (H), and the tab height (J) in relation to an origin provided at the upper-right corner of the index sheet (X0, Y0).

In step S2303 and subsequent steps, if an event occurs based on the editing operation by the user, the general application 101 executes processing corresponding to the event.

If the user clicks the portion on the screen corresponding to the index sheet with the mouse (pointing device) as an event for selecting an index sheet to be edited, then the processing advances from step S2304 to step S2309. In step S2309, the general application 101 reads the coordinates (XX, YY) of the portion of the screen clicked with the mouse pointer.

In step S2310, the general application 101 converts the coordinates (XX, YY) of the portion of the screen clicked with the mouse pointer into coordinates (X, Y) in relation to the origin (X0, Y0) (the upper-right corner of the index sheet).

In addition, the general application 101 determines whether the effective coordinate area of the tab area has been selected by using the mouse based on the converted coordinate values (X, Y).

If each value of the converted coordinates (X, Y) satisfies the following conditions, because the user has selected a tab of an index sheet, the general application 101 extracts (calculates the sheet number of) an index sheet corresponding to the selected tab:

X1<X<X2

Y0<Y<(Y0+H).

In the present exemplary embodiment, by calculating an integer value of an expression “(Y−Y0)/J”, the general application 101 can calculate the page number of the selected index sheet if the page number of the first index sheet is “0”.

More specifically, the index sheet number is equivalent to the chapter number of the chapter stored in the area that stores the information about the index sheet edited in the editing operation (i.e., the index sheet information storage area illustrated in FIG. 21).

If it is determined that no mouse event has occurred, then the processing advances to step S2305. In step S2305, the general application 101 determines whether a tab editing event has occurred.

If it is determined that a tab editing event has occurred (YES in step S2305), then the processing advances to step S2308. In step S2308, the general application 101 changes the screen to a screen for editing the format of the character string of the name of the chapter to be printed in the index sheet tab.

The format of the character string set via the screen displayed in step S2308 is stored in the index sheet information (FIG. 21) corresponding to the chapter identified by a chapter number calculated in step S2310. The detailed content of the processing in step S2308 is described in the above-described flow chart of FIG. 14.

If it is determined that no tab editing event has occurred (NO in step S2305), then the processing advances to step S2306. In step S2306, the general application 101 determines whether an index sheet editing event has occurred. If it is determined that an index sheet editing event has occurred (YES in step S2306), then, the processing advances to step S2307. In step S2307, the general application 101 changes the display screen to the index sheet editing screen. The information about the index sheet (FIG. 21) identified by the chapter number calculated in step S2310 stores the information edited in step S2307.

If it is determined that an event for ending the editing has occurred (Yes in step S2303), then the processing advances to step S2311. In step S2311, the general application 101 ends the index sheet setting processing based on the information edited by executing the above-described operation.

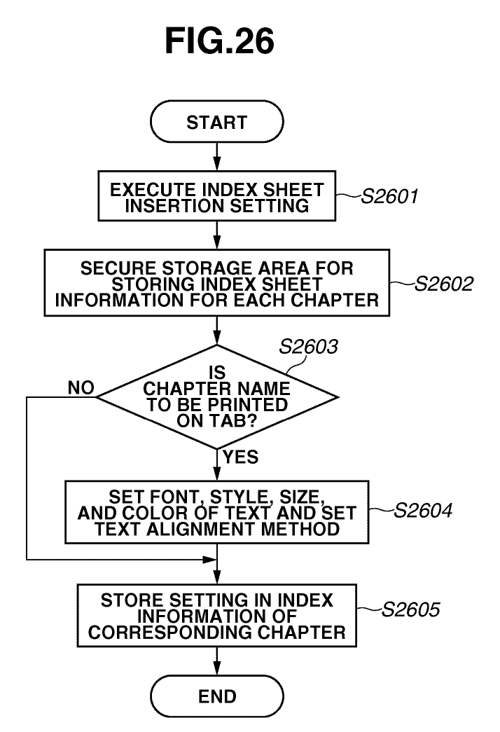

FIG. 26 is a flow chart illustrating an example of processing for inputting information about the index sheet described above according to the present exemplary embodiment.

Referring to FIG. 26, in step S2601, the user starts the processing for setting an index sheet via the screen illustrated in FIG. 15. Then, the processing advances to step S2602. In step S2602, based on the set number of index sheets, the bookbinding application 104 secures an area for storing the information about the index sheets corresponding to the number of necessary chapters, as illustrated in FIG. 21.

In step S2603, the bookbinding application 104 determines whether printing of the chapter name in the tab of the index sheet has been instructed. The determination in step S2603 is executed based on a result of determination as to whether the check box 1501 has been checked.

If it is determined that the printing of the chapter name in the tab of the index sheet has been instructed (YES in step S2603), then the processing advances to step S2604. In step S2604, the user designates the type, style, size, color, and alignment method of the font of the character string to be printed in the tab (FIGS. 16 through 18).

In step S2605, the bookbinding application 104 stores information about the index sheet as the information about the index sheet of the corresponding chapter together with the set tab information.

If it is determined that printing in the tab is not set (NO in step S2603), then the processing advances to step S2605. In step S2605, the bookbinding application 104 stores the index sheet information.

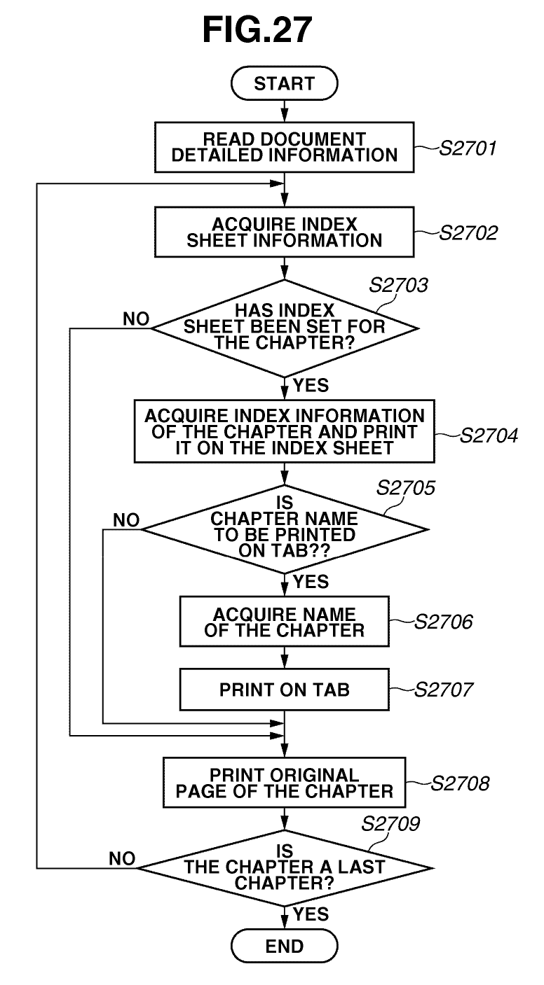

FIG. 27 is a flow chart illustrating an example of processing for printing document information according to the present exemplary embodiment.

Referring to FIG. 27, in step S2701, the electronic original despooler 105 reads the document detailed setting information 702 of the document information illustrated in FIG. 19. In step S2702, the electronic original despooler 105 acquires the index sheet information 805 included in the document detailed setting information 702.

More specifically, the electronic original despooler 105 determines whether index sheet information has been set to the current chapter based on the information 805 (FIG. 21). If it is determined that index sheet information has been set to the current chapter (YES in step S2701), then the processing advances to step S2704. In step S2704, the electronic original despooler 105 acquires the information about the index sheet of the chapter and prints the index sheet.

In step S2705, the electronic original despooler 105 determines whether the user has instructed printing of the chapter name in the index sheet tab. If it is determined that the user has instructed printing of the chapter name in the index sheet tab (YES in step S2705), then the processing advances to step S2706. In step S2706, the electronic original despooler 105 acquires the chapter name of the chapter from the chapter detailed setting information of the corresponding chapter.

In step S2707, the electronic original despooler 105 outputs a GDI function to the graphic engine of the OS (the GDI) to print the chapter name in the index sheet tab according to the font, size, and alignment method of the character string, which is designated in the information about the corresponding index sheet.

Then, the graphic engine converts the GDI function into a drawing function (DDI function) that can be interpreted by the printer driver 106. In addition, the printer driver 106 generates print data of the printer control language that can be interpreted by the printer 107 according to the drawing function transmitted from the graphic engine. Thus, the present exemplary embodiment executes processing for printing on the tab sheet.

On the other hand, if it is determined that information about the index sheet is not set in the chapter (NO in step S2703) or if it is determined that printing in the tab has not been instructed by the user (NO in step S2705), then the processing advances to step S2708.

In step S2708, the electronic original despooler 105 outputs the GDI function to the graphic engine to print each original page based on the information about the original page included in the chapter. When the processing for printing all the original pages of the chapter is completed, then the processing advances to step S2709. In step S2709, the electronic original despooler 105 determines whether the chapter is the last chapter.

If it is determined that the chapter is not the last chapter (NO in step S2709), then the processing returns to step S2702. In step S2702, the electronic original despooler 105 acquires the index sheet information 805 (FIG. 20) of a subsequent chapter and executes processing similar to that described above.

When the print processing of all the original pages and index sheets inserted in the document ends, the print processing ends.

In displaying a print preview of the document information, it is also useful if the “printing” operation is substituted with an operation for “rendering into and displaying in the print preview”. Accordingly, the user can display the set index sheet and each original page as a print preview.

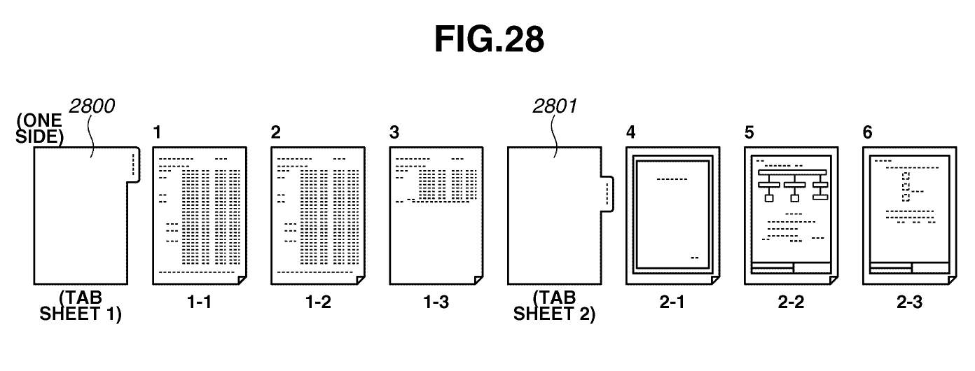

FIG. 28 illustrates an example of a print preview displayed in the above-described manner. Referring to FIG. 28, index sheets 2800 and 2801 are inserted in the top of the respective chapters. Then, the print preview 1102 is displayed.

Each of the index sheets 2800 and 2801 is displayed in a state in which a tab is provided thereto. The character string to be printed in the tab is displayed according to the set font, size, and alignment method set by the user.

Accordingly, the user can recognize the page position at which the index sheet is inserted at a mere glance. In addition, the user can recognize the shape of the index sheet at a glance because the position of the index sheet tab is displayed by displaying the index sheet tab positions in a mutually offset state starting from the first index sheet 2800 downwards.

By executing the above-described processing, the user can print the character string in the index sheet tab according to the index sheet information designated via the screen illustrated in FIG. 16.

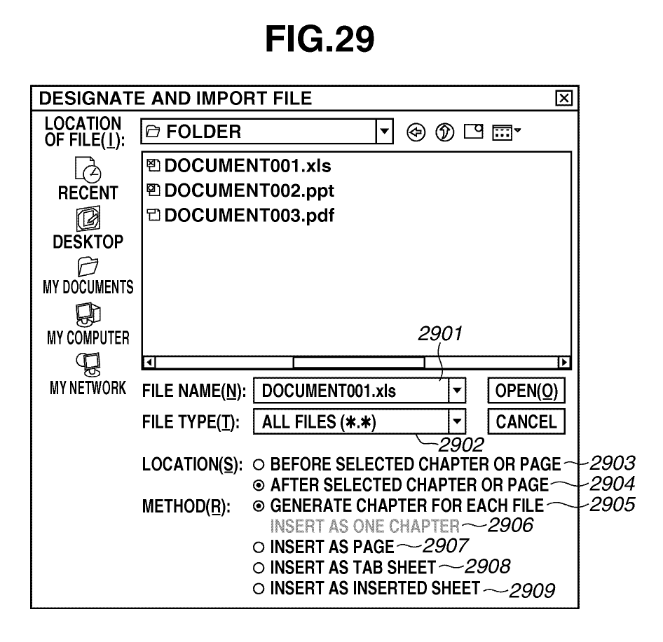

FIG. 29 illustrates an example of a screen (window) for setting the setting item “import designated file”, which is executed by the bookbinding application 104 according to the present exemplary embodiment.

Referring to FIG. 29, an area 2901 is an area for designating application data to be newly added to the currently opened book file. In addition, an area 2902 is an area for designating the type (identifier) of the application data.

In addition, in a “location” field, if an item “before selected chapter or page” check box 2903 is checked, then the index sheet is inserted before the chapter or page selected in the tree field 1101 (FIG. 10) or the preview field 1102.

Furthermore, in the location field, if an item “after selected chapter or page” check box 2904 is checked, then the index sheet is inserted after the chapter or page selected in the tree field 1101 (FIG. 10) or the preview field 1102.

In addition, in a “method” field, if an item “generate chapter for each file” check box 2905 is checked, then the bookbinding application 104 newly generates chapters in the number equivalent to the number of files to be inserted from the insertion position designated in the location field. The bookbinding application 104 arranges a page of the corresponding file to each of the generated chapter.

If an “insert as one chapter” check box 2906 is checked, the bookbinding application 104 newly generates a chapter whose chapter number is “1” at the insertion position. Furthermore, the bookbinding application 104 arranges each page of the file to be inserted in the chapter.

If an “insert as page” check box 2907 is checked, the bookbinding application 104 arranges each page at the insertion position as it is. If an “insert as tab sheet” check box 2908 is checked, the bookbinding application 104 arranges each page of the file to be inserted, regardless of the insertion position, in the top of each chapter included in the book file page by page.

If an “insert as inserted sheet” check box 2909 is checked, the bookbinding application 104 arranges each page of the file to be inserted, regardless of the insertion position, in the top of each chapter included in the book file page by page.

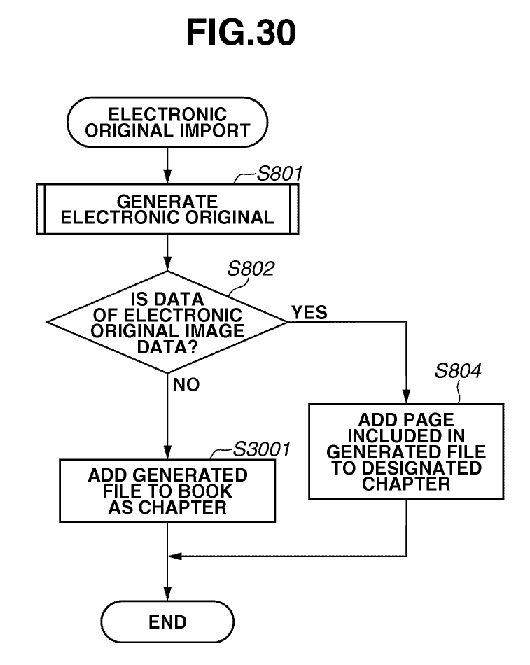

FIG. 30 is a flow chart illustrating an example of processing for importing an electronic original file according to the present exemplary embodiment, which is executed to print the index sheet during the processing. The processing will be described in detail below with reference to FIG. 30.

In the example illustrated in FIG. 30, processing similar to that illustrated in the flowchart of the electronic original file importing processing illustrated in FIG. 8 are provided with the same step number.

Referring to FIG. 30, in step S801, the bookbinding application 104 activates the application program that has generated the designated application data. Further, the bookbinding application 104 designates the electronic document writer 102 as the device driver. Moreover, the bookbinding application 104 converts the application data into electronic document data by printing and outputting the application data by the electronic document writer 102.

When the application data is completely converted into the electronic document data, the processing advances to step S802. In step S802, the bookbinding application 104 determines whether the converted electronic document data is image data. If a Windows® OS is used, the determination in step S802 can be executed according to a file extension of the application data.

For example, if the file extension is “.bmp”, the converted electronic document data can be determined as bitmap data. If the file extension is “.jpg”, then the converted electronic document data can be determined as JPEG image data. Further, if the file extension is “.tiff”, then the converted electronic document data can be determined as tiff image data. In addition, if the electronic original data is image data as described above, the bookbinding application 104 can directly generate an electronic original file from the image data without activating the application program as in step S801. Accordingly, processing in step S801 can be omitted.

If it is determined that the converted electronic document data is not image data (NO in step S802), then the processing advances to step S3001. In step S3001, the bookbinding application 104 imports the electronic document file generated in step S801 by adding the file to the book of the currently opened book file.

On the other hand, if it is determined that the converted electronic document data is image data (YES in step S802), then the processing advances to step S804. In step S804, the bookbinding application 104 imports the data by basically, not adding a new chapter and adding each original page included in the electronic document file generated in step S801 to the designated chapter.

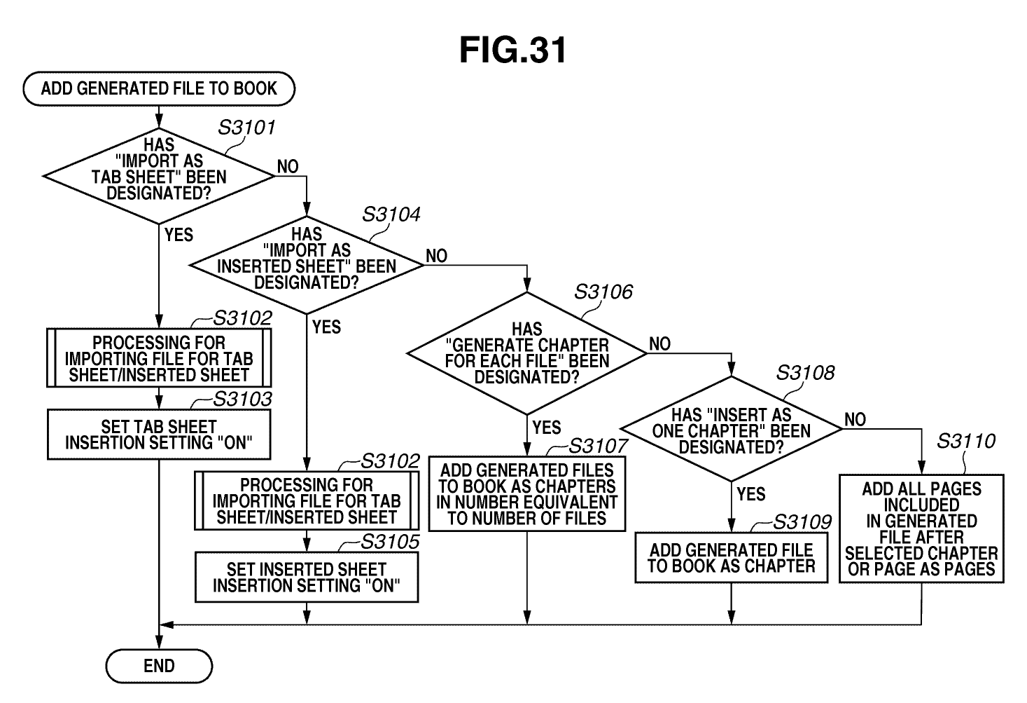

FIG. 31 is a flow chart illustrating an example of processing for adding the electronic original file generated in step S801 to the book of the currently opened book file, which is executed in step S3001 illustrated in the flow chart of FIG. 30 according to the present exemplary embodiment.

Referring to FIG. 31, in step S3101, if “import as tab sheet” has been designated, then the processing advances to step S3102. In step S3102, the bookbinding application 104 executes processing for importing a file of data to be printed on the index sheet or the inserted sheet. In step S3103, the bookbinding application 104 executes a setting for inserting the index sheet. More specifically, the user selects the setting “index sheet” via the area 1500 to instruct a combination of sheets to be inserted via the sheet insertion setting screen.

If it is determined that the setting “import as tab sheet” has not been designated (NO in step S3101), then, the processing advances to step S3104. In step S3104, the bookbinding application 104 determines whether the setting “import as inserted sheet” has been designated.

If it is determined that the setting “import as inserted sheet” has been designated (YES in step S3104), then the processing advances to step S3102. In step S3102, the bookbinding application 104 executes the processing for importing the file including data to be printed on the index sheet or the inserted sheet.

In step S3105, the bookbinding application 104 executes a setting of an inserted sheet to be inserted. More specifically, the user selects the setting “inserted sheet” via the area 1500 to instruct a combination of sheets to be inserted via the sheet insertion setting screen.

If it is determined that the setting “import as inserted sheet” has not been selected (NO in step S3104), then the processing advances to step S3106. In step S3106, the bookbinding application 104 determines whether the setting “generate chapter for each file” has been designated.

If it is determined that the setting “generate chapter for each file” has been designated (YES in step S3106), then the processing advances to step S3107. More specifically, the bookbinding application 104 imports the data of the file by generating a new chapter in the book of the currently opened book file in the number equivalent to the number of electronic original files generated in step S801 and adding the newly generated chapter (fourth importing processing).

If it is determined that the setting “generate chapter for each file” has not been designated (NO in step S3106), then the processing advances to step S3108. In step S3108, the bookbinding application 104 determines whether the setting “insert as one chapter” has been designated. If it is determined that the setting “insert as one chapter” has been designated (YES in step S3108), then the processing advances to step S3109.

More specifically, the bookbinding application 104 imports the electronic original file generated in step S801 into the currently opened book file by adding the same to the currently opened book file as a new chapter (third importing processing).

If it is determined that the setting “insert as one chapter” has not been designated (NO in step S3108), then the processing advances to step S3110.

In step S3110, the bookbinding application 104 imports all the pages included in the electronic original file generated in step S801 in the currently opened book file as pages by adding the same to the currently opened book file as pages (second importing processing).

In the above-described manner, the user can automatically execute a setting of an index sheet or an inserted sheet to be inserted together with the processing for importing a file as well as generating a new book file.

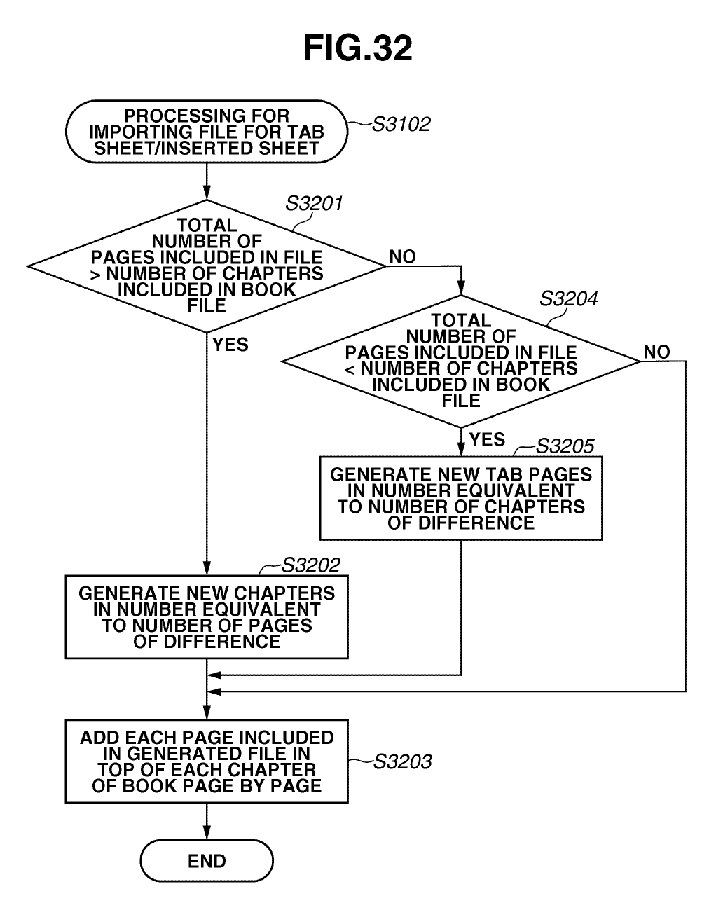

FIG. 32 is a flow chart illustrating an example of processing for importing a file of an index sheet or an inserted sheet executed in step S3102 in the processing illustrated in FIG. 32 (first importing processing) according to the present exemplary embodiment.

Referring to FIG. 32, in step S3201, the bookbinding application 104 compares the number of pages included in the electronic original file (the electronic original file generated in step S801), which is to be imported into the book of the currently opened book file, with the number of chapters included in the book file.

If it is determined that the number of pages of the file is greater than the number of the chapters (YES in step S3201), then the processing advances to step S3202. In step S3202, the bookbinding application 104 generates new chapters in the number equivalent to the number of pages of difference from the number of the chapters.

If it is determined that the number of pages of the file is not greater than the number of the chapters (NO in step S3201), then the processing advances to step S3204. In step S3204, the bookbinding application 104 determines whether the number of the chapters included in the electronic original file is greater than the number of pages included therein. If it is determined that the number of the chapters included in the electronic original file is greater than the number of pages included therein (YES in step S3204), then the processing advances to step S3205. In step S3205, the bookbinding application 104 newly generates index sheet pages in the number equivalent to the number of chapters of difference from the number of pages.

In step S3203, the bookbinding application 104 imports each page of the electronic original file by adding the same to the first page of each chapter of the currently opened book file page by page.

On the other hand, if it is determined that the number of the chapters included in the electronic original file is not greater than the number of pages included therein (NO in step S3204), then the processing advances to step S3203.

In the above-described manner, if the number of pages included in the file to be imported is smaller than the number of chapters included therein, then the bookbinding application 104 generates index sheet pages (blank pages) in the number equivalent to the number of the chapters of difference (the extra number of chapters) and automatically inserts the generated pages in the top of the chapters.

On the other hand, if the number of index sheet pages included in the file to be imported is greater than the number of the chapters, then the bookbinding application 104 automatically generates chapters in the number equivalent to the extra number of index sheet pages and imports the generated index sheet pages into the chapters page by page.

With the above-described configuration, when the user imports the electronic original files generated by the user as data to be printed on a sheet (on an inserted sheet) into the currently opened book file, the bookbinding application 104 can import the electronic original files in an appropriate order of index sheets (or inserted sheets) to be printed.

Accordingly, the user can execute the index sheet printing processing (or the inserted sheet printing processing) with an easy operation.

In using the bookbinding application 104, the electronic original file can be imported into the book file also by dragging and dropping application data on the tree field 1101 or the preview field 1102 of the screen illustrated in FIG. 10.

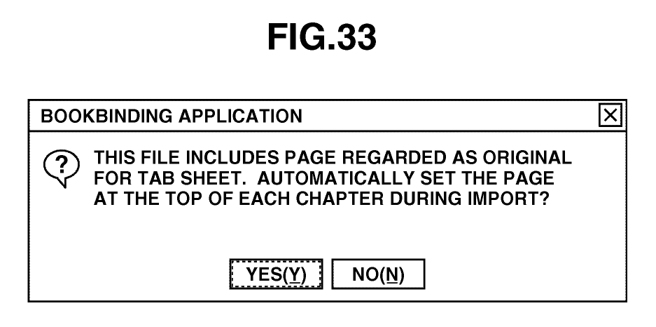

In the electronic original file importing processing for printing on an index sheet according to the present exemplary embodiment, it is also useful if the bookbinding application 104 displays a message illustrated in FIG. 33 when the electronic original file is imported by the above-described drag-and-dropping operation.

In this case, if an electronic original is imported by a dragging and dropping operation, the user is enabled to select whether to import the electronic original as the page to be printed on the index sheet (in other words, the user can set whether to execute the processing in step S3102).

If the user has selected to import the electronic original as the page to be printed on the index sheet, then the bookbinding application 104 executes the processing for importing the file to be printed on the index sheet or the inserted sheet in step S3102.

On the other hand, if the user has not selected to import the electronic original as the page to be printed on the index sheet, then the bookbinding application 104 adds chapters whose number is equivalent to the number of electronic original files and imports the chapters as in step S3107 illustrated in FIG. 31.

In the electronic original importing processing for printing on the index sheet according to the present exemplary embodiment, the bookbinding application 104 recognizes the width and the height of each of the pages included in the electronic original when the user imports the electronic original. In addition, the bookbinding application 104 automatically determines whether the electronic original includes the page to be printed on the index sheet.

If it is determined that the electronic original includes the page to be printed on the index sheet, then the bookbinding application 104 imports the electronic original as pages to be printed on index sheet (in other words, the bookbinding application 104 executes the import processing in step S3102).

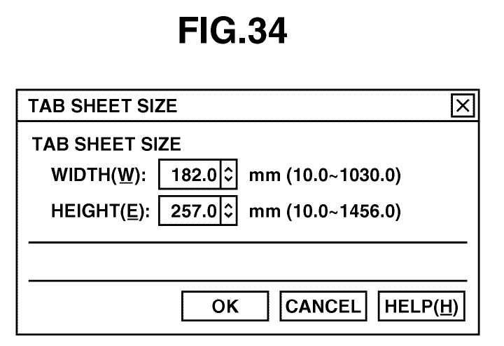

FIG. 34 illustrates an example of a screen via which the user can previously define the size of the page to be printed on an index sheet by using the bookbinding application 104.

When the processing for importing an electronic original is executed, the bookbinding application 104 determines whether a page having the size defined via the screen illustrated in FIG. 34 is included in the pages of the electronic original. If it is determined that any page having the size defined via the screen illustrated in FIG. 34 is included in the pages of the electronic original, then the bookbinding application 104 recognizes the page as a page to be printed on an index sheet and executes the importing processing in step S3102.

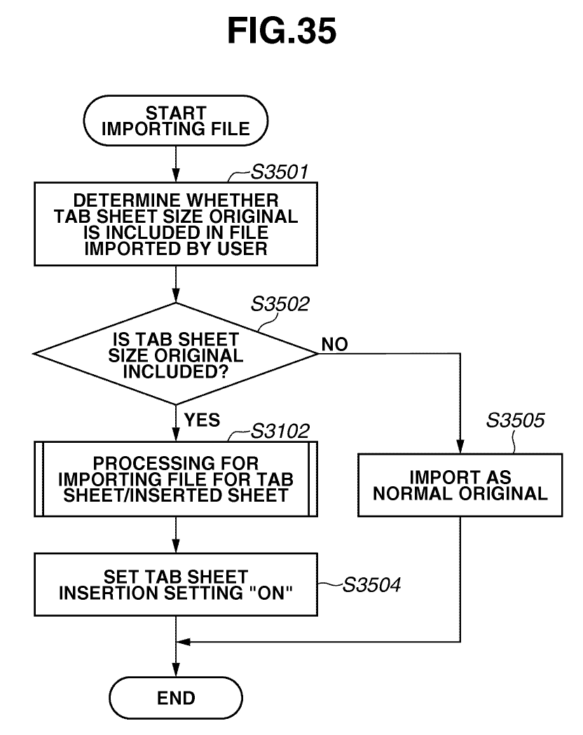

FIG. 35 is a flow chart illustrating an example of processing for importing an electronic original for printing on an index sheet according to the present exemplary embodiment, which is executed with a dragging and dropping operation.

When an electronic original file is imported by the user with the above-described dragging and dropping, in step S3501, the bookbinding application 104 starts processing for importing an electronic original file. In step S3502, the bookbinding application 104 determines whether a page to be printed on an index sheet is included in the electronic original file.

If it is determined that a page to be printed on an index sheet is included in the electronic original file (YES in step S3502), then the processing advances to step S3102. In step S3102, the bookbinding application 104 executes the processing for importing a file of data to be printed on an index sheet or an inserted sheet. In step S3504, the setting for inserting an index sheet is set valid.

On the other hand, if it is determined that a page to be printed on an index sheet is not included in the electronic original file (NO in step S3502), then the processing advances to step S3505. In step S3505, the bookbinding application 104 imports the electronic original file as a normal original file. More specifically, in this case, the bookbinding application 104 imports the file by adding chapters in the number equivalent to the number of electronic original files thereto.

The processing in step S3102 is as described above. Accordingly, the description thereof will not be repeated here.

As described above, when new electronic original files are imported by dragging and dropping on a currently edited book file, the bookbinding application 104 determines whether a page to be printed on an index sheet is included in the electronic original files. If it is determined that a page to be printed on an index sheet is included in the electronic original files, then the bookbinding application 104 imports the page in the first page of each chapter and executes a setting of an index sheet to be inserted.

Accordingly, the user can execute printing of the index sheet with easy operation.

In the present exemplary embodiment, even if a page to be printed on an index sheet exists in the currently opened book file in an order other than the printing order, the bookbinding application 104 can easily rearrange the pages so that the page to be printed on an index sheet is included in the first page of each chapter.

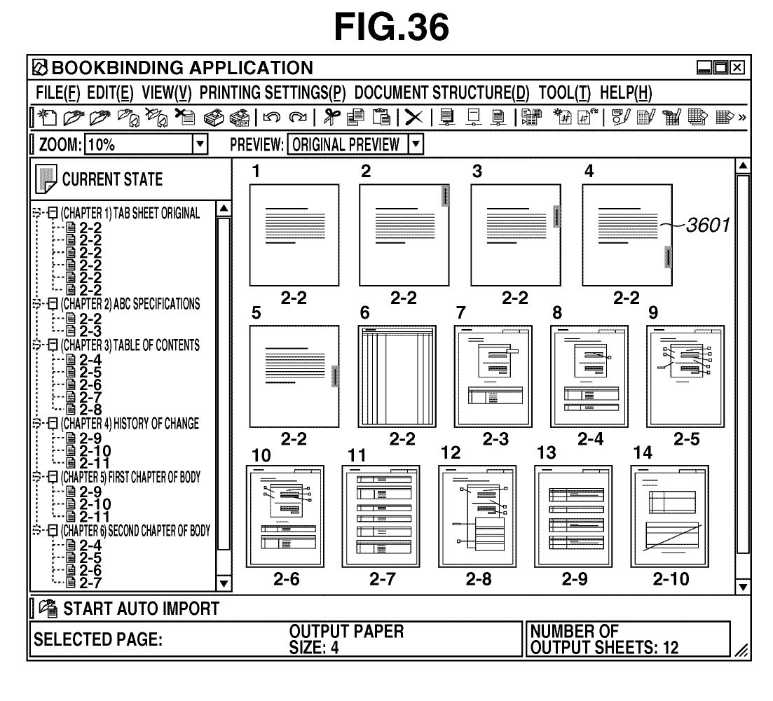

FIG. 36 illustrates an example of a print preview displayed by the bookbinding application 104 as a result of dragging and dropping by the user of the electronic original file including a page to be printed on an index sheet. In the example illustrated in FIG. 36, an original 3601 to be printed on an index sheet is inserted in the top of the book file as a chapter.

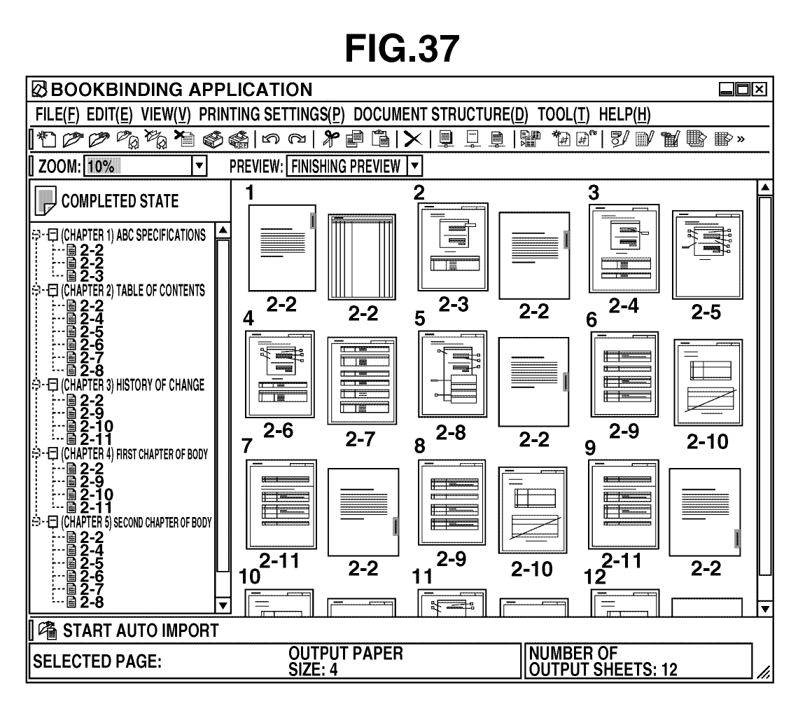

If a conventional bookbinding application is used, if a page to be printed on an index sheet is mixedly included in the currently edited book file in an order other than the printing order of printing pages to be printed on an index sheet, then it is necessary to manually rearrange the pages so that the page to be printed on an index sheet is included in the top of each chapter as illustrated in FIG. 37.

FIG. 37 illustrates an example of a print preview displayed after the original page 3601 to be printed on an index sheet is moved by the user to the top of each chapter to achieve a desired printing order.

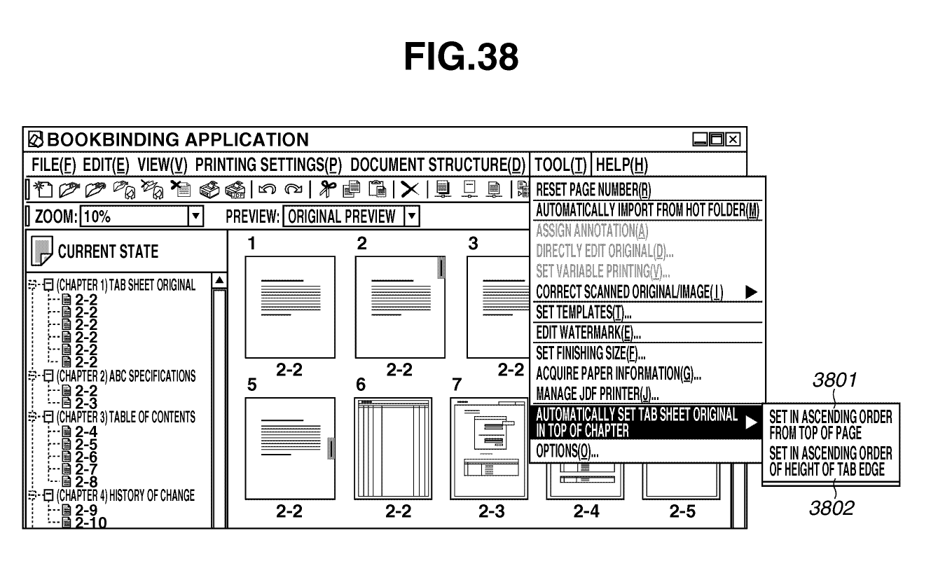

On the other hand, the bookbinding application 104 according to the present exemplary embodiment provides new menus 3801 and 3803 illustrated in FIG. 38. More specifically, if a page to be printed on an index sheet and a normal page to be printed are mixedly included in the currently opened book file in an order different from the desired printing order, the present exemplary embodiment can rearrange the pages so that the original page to be printed on an index sheet is included as the first page of each chapter with easy operation.

Accordingly, it is not necessary for the user to rearrange the pages to be printed on an index sheet in a desired printing order, as necessary in a conventional method.

More specifically, if the user sets a setting “arrange pages from first page in ascending order” 3801 via a screen illustrated in FIG. 38, then the bookbinding application 104 extracts the page to be printed on an index sheet included in the book file and moves the page to be printed on an index sheet to the top of each chapter page by page.

If the user has designated a setting “arrange pages in ascending order of height of tab position” 3802, then the bookbinding application 104 extracts the pages to be printed on an index sheet and automatically recognizes the positions of the tabs included in the pages to be printed on an index sheet and moves the extracted pages to the top of each chapter starting from the page having a highest tab position.

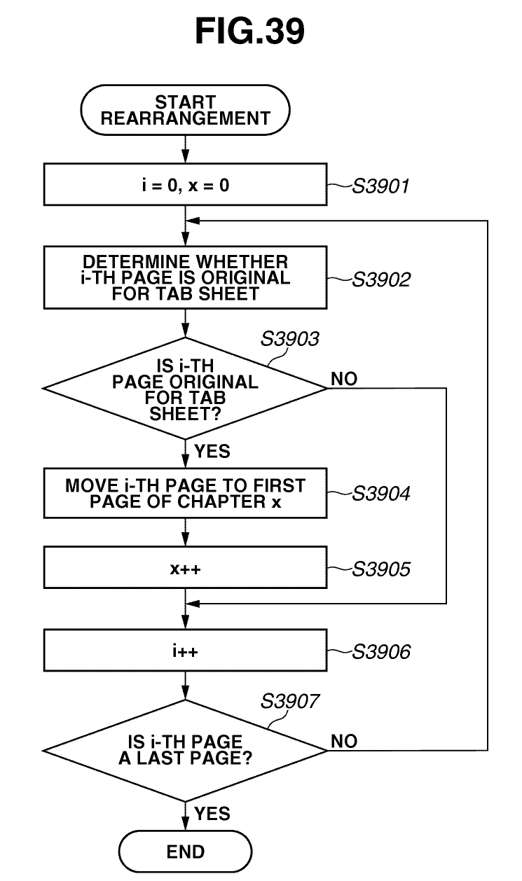

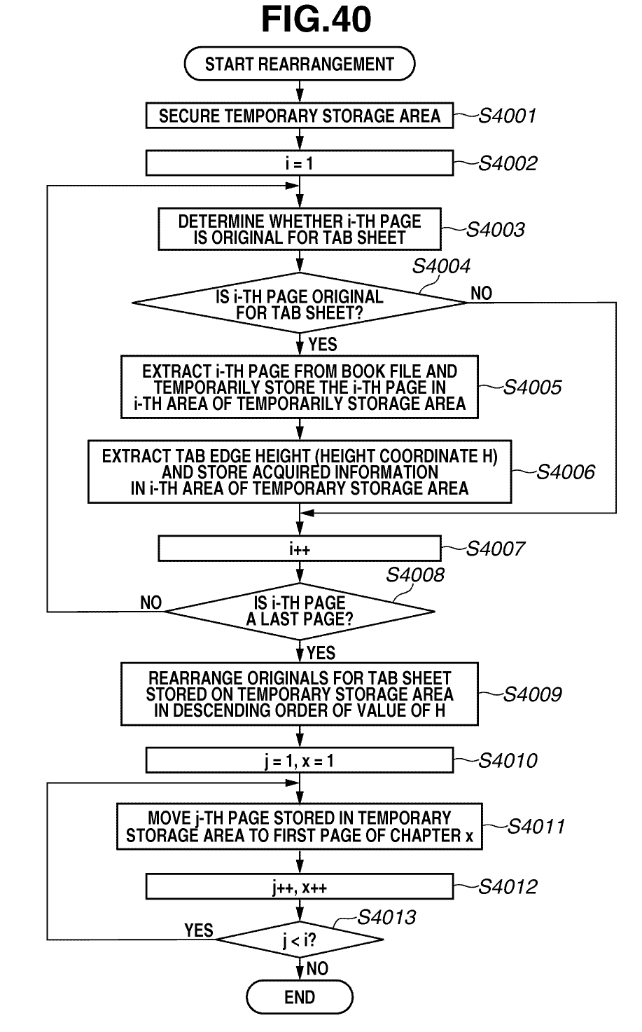

FIGS. 39 and 40 are flow charts illustrating an example of processing for automatically rearranging the order of pages to be printed on an index sheet according to the present exemplary embodiment.

FIG. 39 is a flow chart illustrating an example of the automatic rearranging processing executed by the bookbinding application 104 when the user designates the setting “arrange pages from first page in ascending order” 3801 via the screen illustrated in FIG. 38.

Referring to FIG. 39, when the user selects the setting “arrange pages from first page in ascending order” 3801, in step S3901, the bookbinding application 104 initializes values “i” and “x” with value “0”.

In step S3902, the bookbinding application 104 determines the type of an i-th page. In step S3903, the bookbinding application 104 determines whether the i-th page is a page to be printed on an index sheet. If it is determined that the i-th page is a page to be printed on an index sheet (YES in step S3903), then the processing advances to step S3904. In step S3904, the bookbinding application 104 moves the i-th page to the first page of an x-th chapter.

In step S3905, the bookbinding application 104 increments the value x, and, in step S3906, increments the value i.

On the other hand, if it is determined that the i-th page is not a page to be printed on an index sheet (NO in step S3903), then the processing advances to step S3906. In step S3907 after step S3906, the bookbinding application 104 determines whether the i-th page is the last page of the book file. If it is determined that the i-th page is not the last page of the book file (NO in step S3907), then the processing returns to step S3902.

The present exemplary embodiment repeats the above-described processing for all the pages included in the electronic original file.

Now, processing for automatically rearranging the order of the pages, which is executed when the user selects the setting “arrange pages in ascending order of height of tab position” 3802 via the screen illustrated in FIG. 38, will be described in detail below.

When the user selects the setting “arrange pages in ascending order of height of tab position” 3802, in step S4001, the bookbinding application 104 secures a temporary storage area on the external memory 211. In step S4002, the bookbinding application 104 sets an initial value “1” as a value of the parameter “i”.

In step S4003, the bookbinding application 104 determines the type of the i-th page. In step S4004, the bookbinding application 104 determines whether the i-th page is a page to be printed on an index sheet. If it is determined that the i-th page is a page to be printed on an index sheet (YES in step S4004), then the processing advances to step S4005.

In step S4005, the bookbinding application 104 temporarily stores the i-th page data in an i-th area of the temporary storage area. In step S4006, the bookbinding application 104 extracts the position of tab (height coordinates H) in the i-th page. The bookbinding application 104 stores the extracted coordinates H on the temporary storage area together with the i-th page data.

In step S4007, the bookbinding application 104 increments the parameter value i. In step S4008, the bookbinding application 104 determines whether the i-th page is the last page of the book file.

If it is determined that the i-th page is not the last page of the book file (NO in step S4008), then the processing returns to step S4003. The bookbinding application 104 repeats the processing in step S4003 and subsequent steps until the i-th page is the last page of the book file.

On the other hand, if it is determined that the i-th page is not a page to be printed on an index sheet (NO in step S4004), then the processing advances to step S4007.

When the extraction of the page to be printed on an index sheet and the storage of the extracted page to be printed on an index sheet in the temporary storage area are completed in the above-described manner, the processing advances to step S4009. In step S4009, the bookbinding application 104 rearranges the order of the pages to be printed on an index sheet stored in the temporary storage area in descending order of the tab position height coordinates.

After setting the initial value “1” as the value of the parameters “j” and “x” in step S4010, then the processing advances to step S4011. In step S4011, the bookbinding application 104 moves a j-th page to the top of the x-th chapter and deletes the same from the temporary storage area.

In step S4012, the bookbinding application 104 increments the parameters j and x. In step S4013, the bookbinding application 104 determines whether the value of the parameter j is smaller than that of the parameter i to determine whether the j-th page is the last page of the pages to be printed on an index sheet stored on the temporary storage area.

If it is determined that the j-th page is not the last page of the pages to be printed on an index sheet stored on the temporary storage area (YES in step S4013), then the processing returns to step S4011.

The bookbinding application 104 repeats the above-described processing until no page to be printed on an index sheet remains stored in the temporary storage area.

As described above, in the present exemplary embodiment, the bookbinding application 104 provides the function for rearranging the order of the pages into the printing order desired by the user with a simple operation even if a page to be printed on an index sheet and a normal printing page mixedly exist in the book file in an order different from a specific desired order.

With the above-described configuration, the present exemplary embodiment can save the user's operation of manually rearranging the order of pages to be printed on an index sheet. Accordingly, the present exemplary embodiment having the above-described configuration can enable the user to execute printing on an index sheet with a simple operation.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-301212 filed Nov. 26, 2008, which is hereby incorporated by reference herein in its entirety.

What is claimed is:

1. An information processing method for editing an original file having a hierarchical structure including a chapter page by page, the information processing method comprising:
designating a second original file to be imported into a first original file; and
executing first importing processing for importing each page included in the designated second original file by arranging each page of the second original file into a top of each chapter of the first original file.

2. The information processing method according to claim 1, further comprising executing second importing processing for importing each page of the designated second original file by arranging each page of the second original file into a chapter of the first original file.

3. The information processing method according to claim 1, further comprising executing third importing processing for generating a new chapter in the first original file and arranging the second original file in the generated new chapter.

4. The information processing method according to claim 3, further comprising executing, when a plurality of original files are designated, fourth importing processing for generating new chapters in a number equivalent to a number of the designated plurality of original files in the first original file in the first original file and inserting one designated original file into each of the newly generated chapters.

5. The information processing method according to claim 2, further comprising selecting either one of the plurality of importing processing according to an instruction given by a user.

6. The information processing method according to claim 1, further comprising:
determining whether a page to be printed on an index sheet is included in the second original file; and
selecting the first importing processing according to a result of the determination.

7. The information processing method according to claim 1, further comprising executing a setting of an index sheet to be inserted into the first original file after executing the first importing processing.

8. The information processing method according to claim 1, further comprising:
determining a page to be printed on an index sheet included in the original file and recognizing a position of a tab of the page to be printed on an index sheet; and
inserting each page to be printed on an index sheet into a top of each chapter of the original file according to the position of the tab included in the page to be printed on an index sheet.

9. A computer-readable storage medium storing instructions which, when executed by a computer, cause the computer to perform operations included in the information processing method according to claim 1.

10. An information processing apparatus configured to edit an original file having a hierarchical structure including a chapter page by page, the information processing apparatus comprising:
a designation unit configured to designate a second original file to be imported into a first original file; and
an importing unit configured to import each page included in the second original file designated by the designation unit into a top of each chapter of the first original file.
